(19) United States
(12) Patent Application Publication
(10) Pub. No.: US 2026/0283761 A1
(43) Pub. Date: Sep. 24, 2026

(54) SYSTEMS AND METHODS FOR DENTAL RESTORATIONS

(71) Applicant: BIOMET 3I, LLC, Palm Beach Gardens, FL (US)

(72) Inventors: Alessandro Motroni, Lentate sul Seveso (IT); Angelo Tocchetti, Bottanuco (IT)

(21) Appl. No.: 19/574,077

(22) Filed: Mar. 20, 2026

Related U.S. Application Data
(60) Provisional application No. 63/775,920, filed on Mar. 21, 2025.

(51) Int. Cl. A61C 13/00; G06F 3/01

(52) U.S. Cl. CPC A61C 13/0004; G06F 3/011

(57) ABSTRACT

A computing device is provided that includes a processor and memory including data that, when processed by the processor, enables the computing device to perform various digital dentistry workflows for different types of dental restorations. To assist in the completion of the different types of dental restorations, including during the various digital dentistry workflow processes, devices for establishing a persistent coordinate system and/or reducing invasiveness of restorative components utilized and/or installed throughout the dental restoration process are additionally provided. The restorative components include a dual-function surgical guide and support member for a final restoration prosthesis.

### CROSS-REFERENCE TO RELATED APPLICATIONS

This application claims the benefit of U.S. Provisional Application No. 63/775,920, filed on Mar. 21, 2025, which is incorporated herein by reference in its entirety.

### FIELD OF THE DISCLOSURE

The present application is directed generally to dental reconstructions and specifically to systems and methods for dental restorations.

### BACKGROUND

The present disclosure is generally directed to Computer-Aided Drafting (CAD), and relates more particularly to CAD tools used to support surgical procedures, such as dental procedures.

The use of surgical navigation in the head and neck has made significant advancements recently. Presently, systems are used in otolaryngology, neurosurgery, and oral and maxillofacial surgery for a variety of surgical procedures.

Recent advances allow dentists, oral and maxillofacial surgeons, and maxillofacial prosthodontists to place dental implants accurately or plan surgeries based on actual anatomy of a patient. Some CAD tools even support the creation of objects within the CAD environment based on images taken of anatomy of a patient. Most CAD tools, however, are limited in the types of objects or primitives they can create. Furthermore, existing CAD tools limit the manner in which objects or primitives can be manipulated, especially when dealing with overlapping volumes or complex volumes, which makes customized dental reconstruction planning more difficult. These limitations of existing CAD tools can lead to less-than-optimal reconstruction outcomes and/or extended patient time in the chair during dental reconstructions. Existing dental reconstruction workflows can be cumbersome due to a multiplicity of steps in digitally planning prosthetics for the dental reconstruction.

The dental procedures can involve multiple stages where, based on initial scan data, restorative components are temporarily or permanently installed within the mouth of the patient. However, between the various stages that involve interaction with the mouth of the patient, micro-movements of or in the mouth of the patient may occur. These micro-movements may interfere and slow the dental restoration process, by requiring updates to scan data and/or modification or adjustment or virtually-generated or physically-fabricated restorative components.

In addition, the dental procedures can require multiple types of restorative components including temporary surgical guides and/or support members for the temporary or final restorative prosthesis. Installing, removing, and replacing the surgical guide with the support members can increase the invasiveness of the dental restoration process, and may increase or heighten the risk of injury to the patient.

### SUMMARY

As such, there exists a long-felt but unmet need to improve upon the digital dentistry workflows used during a dental restoration process. The improvements to the digital dentistry workflows should reduce time for the care provider and the patient, while providing an increased rate of success during the design, test, and installation stages of the dental restoration process. In particular, the improvements should provide a persistent coordinate system between virtual, augmented, and/or physical environments that may be acted upon or in during the dental restoration process, reducing the possibility of misalignment and discomfiture and subsequently reducing the time needed for the dental restoration process. In addition, the improvements should reduce the number of temporary and/or permanent restorative components that are installed within the mouth of the patient, thus reducing the invasiveness and the possibility of injury to the patient during the dental restoration process.

In embodiments, scannable devices are installed in a mouth of a patient as part of the initial stages of the dental restoration process. From the scannable devices which provide persistent points of reference within the mouth, a coordinate system may be defined and used during the design, test, and installation stages of the dental restoration process. Using data models trained on the coordinate system, micro-movements of or in the mouth of the patient that occur during the dental restoration process may be addressed using the data models with the modification or adjustment or virtually-generated or physically-fabricated restorative components.

Optionally, the coordinate system may be utilized to align CAD models, virtual reality models and/or environments, augmented reality models and/or environments, and/or physically-manufactured components installable in the mouth of the patient during the dental restoration process.

In embodiments, a restorative component used during the dental restoration process is dual-function, being usable as a surgical guide and support member (e.g., a reinforcement bar, or the like). The restorative component is first installed into the mouth for use as a surgical guide when modifying the mouth (e.g., of the firm tissue such as osseous matter and/or of the soft tissue such as gingiva) for the temporary or final restorative prosthesis. The restorative component then remains installed within the mouth, and is able to receive and/or otherwise engage with the temporary or final restorative prosthesis.

A first aspect of the present disclosure is to provide a system for installation of a dental restoration. The system includes a plurality of devices installable within a mouth of a patient, the plurality of devices being scannable as persistent points of reference during one or more operations of a dental restoration process. The system includes a computerized device with processors configured to execute program instructions stored in memory. The program instructions are configured to cause the processors to acquire scan data of the plurality of devices when installed within the mouth of the patient. The program instructions are configured to cause the processors to define a coordinate system based on the acquired scan data. The program instructions are configured to cause the processors to generate a virtual model of the mouth of the patient using the defined coordinate system. The program instructions are configured to cause the processors to generate a virtual representation of a restorative component of the dental restoration that aligns with the virtual model of the mouth based on the defined coordinate system.

The system of the first aspect may include, optionally, that the generating the virtual representation of a restorative component of the dental restoration includes at least one of receiving one or more user inputs from a care provider to define one or more parameters of the restorative component, and selecting the virtual representation of the restorative component from a library.

The system of the first aspect may include one or more of the previous embodiments and, optionally, that when the virtual representation is selected from the library, the generating the virtual representation of a restorative component of the dental restoration further comprises modifying the selected virtual representation of the restorative component in response to one or more user inputs from a care provider to define one or more parameters of the restorative component.

The system of the first aspect may include one or more of the previous embodiments and, optionally, that the program instructions are configured to cause the processors to generate one or more fabrication instructions for a manufacturing system to manufacture the restorative component.

The system of the first aspect may include one or more of the previous embodiments and, optionally, that the program instructions are configured to cause the processors to provide the virtual model of the mouth and the virtual representation of the restorative component to a care provider. The program instructions are configured to cause the processors to receive one or more user inputs from the care provider. The program instructions are configured to cause the processors to generate one or more control instructions for at least one surgical tool in response to the one or more user inputs based on the defined coordinate system.

The system of the first aspect may include one or more of the previous embodiments and, optionally, that the program instructions are configured to cause the processors to generate an augmented reality overlay of at least one of the virtual model and the virtual representation of the restorative component on the mouth of the patient based on the defined coordinate system. When movement of at least one of the care provider or the patient occurs, the defined coordinate system maintains alignment between the augmented reality overlay and the mouth of the patient.

The system of the first aspect may include one or more of the previous embodiments and, optionally, that the augmented reality overlay is one or more of displayed on lenses of a worn optical device comprising glasses for the care provider, projected onto the mouth of the patient from a worn optical device comprising glasses for the care provider, and projected onto the mouth of the patient from a separately-standing projecting system.

The system of the first aspect may include one or more of the previous embodiments and, optionally, that the restorative component is a dual-function restorative component.

The system of the first aspect may include one or more of the previous embodiments and, optionally, that the dual-function restorative component is installable within the mouth of the patient and usable as a surgical guide to modify an osseous structure of the patient.

The system of the first aspect may include one or more of the previous embodiments and, optionally, that the dual-function restorative component is configured to receive implants to secure the dual-function restorative component to the osseous structure of the patient.

The system of the first aspect may include one or more of the previous embodiments and, optionally, that the dual-function restorative component is configured to engage pre-installed implants within the mouth of the patient to secure the dual-function restorative component to the osseous structure of the patient.

The system of the first aspect may include one or more of the previous embodiments and, optionally, that the pre-installed implants are the plurality of devices that are scannable as the persistent points of reference during one or more operations of the dental restoration process.

The system of the first aspect may include one or more of the previous embodiments and, optionally, that the dual-function restorative component remains installed within the mouth of the patient as part of the dental restoration post-modification of the osseous structure. The dual-function restorative component is operable as a support member and configured to receive and engage with a restorative prosthesis via at least one of a fastener or an interlocking assembly.

The system of the first aspect may include one or more of the previous embodiments and, optionally, that the program instructions are further configured to cause the one or more processors to, in response to observed changes in a location or a position of the plurality of devices in the mouth of the patient from additional acquired scan data, update one or more of the defined coordinate system, the generated virtual model of the mouth, and the generated virtual representation of the restorative component.

The system of the first aspect may include one or more of the previous embodiments and, optionally, that the plurality of devices are removably installable during the dental restoration process, to be removed upon completion of the dental restoration process.

The system of the first aspect may include one or more of the previous embodiments and, optionally, that the plurality of devices are installed during the dental restoration process and remain as components of the dental restoration.

A second aspect of the present disclosure is to provide a dual-function restorative component for a dental restoration, the dual-function restorative component being usable as a surgical guide and configured to receive one or more surgical tools to modify an osseous structure of a patient when the dual-function restorative component is installed within a mouth of the patient, the dual-function restorative component being operable as a support member and configured to receive and engage with a restorative prosthesis via at least one of a fastener or an interlocking assembly post-modification of the osseous structure of the patient.

A third aspect of the present disclosure is to provide a method. The method may include, but is not limited to, acquiring scan data of a plurality of devices when installed within a mouth of a patient. The method may include, but is not limited to, defining a coordinate system based on the acquired scan data. The method may include, but is not limited to, generating a virtual model of the mouth of the patient using the defined coordinate system. The method may include, but is not limited to, generating a virtual representation of a restorative component of a dental restoration that aligns with the virtual model of the mouth based on the defined coordinate system.

The method of the third aspect may include, optionally, providing the virtual model of the mouth and the virtual representation of the restorative component to a care provider. The method may include, but is not limited to, receiving one or more user inputs from the care provider. The method may include, but is not limited to, at least one of generating one or more fabrication instructions for a manufacturing system to manufacture the restorative component, generating one or more control instructions for at least one surgical tool in response to one or more user inputs based on the defined coordinate system, and generating an augmented reality overlay of at least one of the virtual model and the virtual representation of the restorative component on the mouth of the patient based on the defined coordinate system, where when movement of at least one of the care provider or the patient occurs, the defined coordinate system maintains alignment between the augmented reality overlay and the mouth of the patient.

The method of the third aspect may include one or more of the previous embodiments and, optionally, that the restorative component is a dual-function restorative component operable as a surgical guide as a support member for a restorative prosthesis.

The phrases “at least one”, “one or more”, and “and/or”, as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being modified in all instances by the term “about” or “approximately”. As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The use of “substantially” in the present disclosure, when referring to a measurable quantity (e.g., a diameter or other distance) and used for purposes of comparison, is intended to mean within 5% of the comparative quantity. The terms “substantially similar to,” “substantially the same as,” and “substantially equal to,” as used herein, should be interpreted as if explicitly reciting and encompassing the special case in which the items of comparison are “similar to,” “the same as” and “equal to,” respectively.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein. The use of “engaged with” and variations thereof herein is meant to encompass any direct or indirect connections between components.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and claims themselves.

These and other advantages will be apparent from the disclosure of the inventions contained herein. The above-described embodiments, objectives, and configurations are neither complete nor exhaustive. The Summary is neither intended nor should it be construed as being representative of the full extent and scope of the present disclosure. Moreover, references made herein to “the present disclosure” or aspects thereof should be understood to mean certain embodiments of the present disclosure and should not necessarily be construed as limiting all embodiments to a particular description. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings

It is to be appreciated that any feature or aspect described herein can be claimed in combination with any other features or aspects as described herein, regardless of whether the features or aspects come from the same described embodiment

Any one or more aspects described herein can be combined with any other one or more aspects described herein. Any one or more features described herein can be combined with any other one or more features described herein. Any one or more embodiments described herein can be combined with any other one or more embodiments described herein.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosure.

FIG. 1 is a block diagram of a system according to at least one embodiment of the present disclosure;

FIG. 2 is a block diagram illustrating details of a computing device according to at least one embodiment of the present disclosure;

FIG. 3 is a flow diagram illustrating a second method according to at least one embodiment of the present disclosure;

FIG. 4 is a flow diagram illustrating a third method according to at least one embodiment of the present disclosure;

FIG. 5 is a flow diagram illustrating a third method according to at least one embodiment of the present disclosure;

FIG. 6A-6C illustrate a number of views of a patient mouth including devices for establishing a persistent coordinate system during a restoration process according to at least one embodiment of the present disclosure;

FIG. 7A is a block diagram of a system according to at least one embodiment of the present disclosure;

FIG. 7B is a block diagram of a system according to at least one embodiment of the present disclosure;

FIG. 8 is a flow diagram illustrating a method according to at least one embodiment of the present disclosure;

FIG. 9A-9E illustrate a number of schematics for the locating and installation of a dual-function restorative component used during a restoration process; and

FIG. 10 is a flow diagram illustrating a method according to at least one embodiment of the present disclosure.

It should be understood that the drawings are not necessarily to scale, and various dimensions may be altered. In certain instances, details that are not necessary for an understanding of the disclosure or that render other details difficult to perceive may have been omitted. It should be understood, of course, that the disclosure is not necessarily limited to the particular embodiments illustrated herein. It is noted that any line in the drawings may be illustrated as solid or broken lines, including any section or length of each individual line, without departing from the scope of the present disclosure.

It will be appreciated that recitation of, for example, reference character 117, 117A, 117B, etc. may apply to any combination of reference characters 117, 117A, 117B, etc. In addition, it will be appreciated any reference characters “xx01”, “01”, and “1”, etc. within the figures and the description are referring to the same component within a system or operation of a method.

### DETAILED DESCRIPTION

Although the following text sets forth a detailed description of numerous different embodiments, it should be understood that the legal scope of the description is defined by the words of the claims set forth at the end of this disclosure. The Detailed Description is to be construed as exemplary only and does not describe every possible embodiment of the systems and methods for dental restorations since describing every possible embodiment would be impractical, if not impossible. Numerous alternative embodiments could be implemented, using either current technology or technology developed after the filing date of this patent, which would still fall within the scope of the claims. Additionally, any combination of features shown in the various figures can be used to create additional embodiments of the present disclosure. Thus, dimensions, aspects, and features of one embodiment of the systems and methods for dental restorations can be combined with dimensions, aspects, and features of another embodiment of the systems and methods for dental restorations to create the claimed embodiment.

Embodiments of the present disclosure provide solutions to a number of different problems associated with CAD tools and the use of CAD tools in connection with planning or performing surgical procedures and dental reconstructions. As an example, embodiments of the present disclosure provide CAD tools that are configured to generate and manipulate freeform objects across multiple dimensions, including optionally based on a persistent coordinate system. Embodiments of the present disclosure also provide CAD tools that can communicate with a manufacturing system, which can produce complex physical items according to the objects defined in the CAD tools. The flexibility and customization offered by the CAD tools proposed herein supports the ability to rapidly create customized surgical guides, stacked guides, stacked components, cutting templates, dual-function restorative components operable as a guide and a support member for temporary or final dental prosthesis components, dental restoration systems and components thereof, or the like in real-time, which translates to improved patient outcomes and/or reduced chair time for a patient during a surgical procedure.

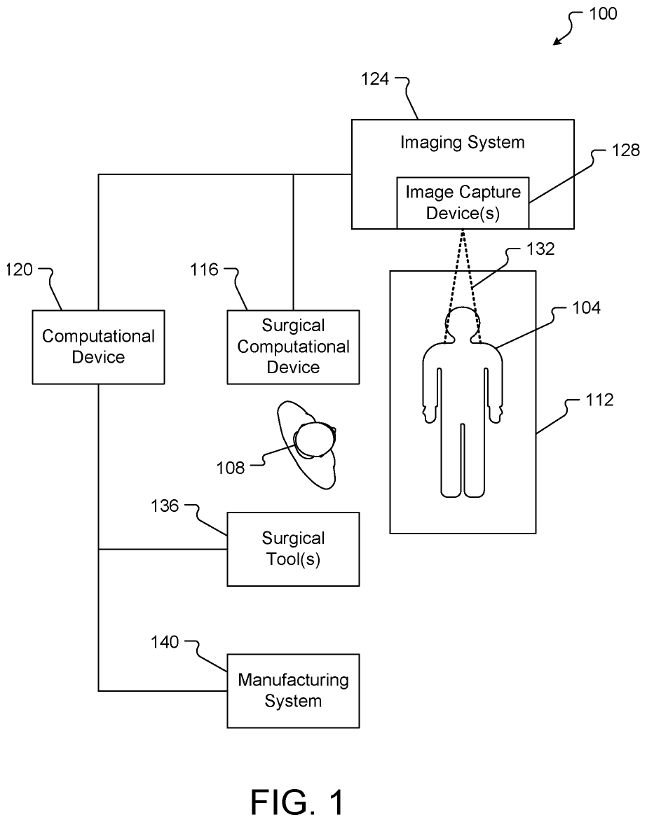

Turning initially to FIG. 1, a system 100 is illustrated in accordance with at least some embodiments of the present disclosure. The system 100 may correspond to a surgical system, computing system, communication system, or combination thereof. In some embodiments, the system 100 includes a surgical system that enables a care provider 108 (e.g., surgeon or other medical professional) to perform a surgical procedure on a patient 104. Illustratively, the system 100 may include a table or chair 112 that supports the patient 104 during the surgical procedure. The system 100 is also shown to include one or more computational devices 116, 120, an imaging system 124, surgical tools 136, and a manufacturing system 140.

The computational devices 116, 120 may include one or more computational devices 116 that are accessible to the care provider 108 during the surgical procedure. The computational devices 116, 120 may also include one or more computational devices 120 that are remotely located with respect to the table or chair 112. Either computational device 116, 120 may be configured to provide CAD tools to the care provider 108 and may facilitate the planning and/or performing of a surgical procedure. In some embodiments, the computational devices 116, 120 may enable the care provider 108 to plan a surgical procedure and/or dental reconstruction before the patient 104 is on the table or chair 112. Alternatively or in addition, the computational devices 116, 120 may enable the care provider 108 to update plans for a surgical procedure and/or dental reconstruction during the surgical procedure and/or dental reconstruction (e.g., while the patient 104 is on the table or chair 112). As an example, CAD tools and/or imaging tools provided by the computational devices 116, 120 may enable the care provider 108 to plan surgical maneuvers (e.g., plan a cut/incision, plan an implant placement, check an implant placement, visualize an implant placement, adjust an implant placement, plan a bone graft, etc.), build surgical tools (e.g., build a surgical guide, build a collection of surgical guides, customize implants, customize implant-placement tools, etc.), and perform other tasks during a surgical procedure and/or design prosthetic devices, such as healing abutments, scan bodies, permanent abutments, crowns, overdentures, bridges, veneers, etc., support structures, such as implants, fixed or removable bars (e.g., used in bar-supported overdentures and fixed hybrids (onto which the prosthetic is screwed), and other dental restoration components.

As will be appreciated, where a dental restoration includes a bar or other support member, that the bar is designed to distribute occlusal loads and is generally attached to one or more underlying implants. Bar or bar structure types include removable prosthesis bar types, such as round, Dolder, Hader, free-form milled and Paris bar types, and fixed prosthesis bar types, such as Montreal, Montreal with metallic lingual, wrap-around, and hybrid bar types.

A bar structure for a removable overdenture typically comprises a female or outer portion and a male or inner portion. The male portion is attached to at least two anchor elements, tooth, and/or an implant. The female portion is typically polymerized or integral with the removal overdenture. Optionally, a bar structure may be split into one or more resultant portions. Alternatively or in addition, the bar structure as described throughout the present disclosure can be any suitable type of removable or fixed prosthesis bar.

Although the surgical tools 136 and manufacturing system 140 are only depicted as being connected to the computational device 120 for ease of illustration, it should be appreciated that the surgical computational device 116 may also be connected to the surgical tools 136 and/or manufacturing system 140. While two separate computational devices 116, 120 are illustrated, it should be appreciated that the system 100 may include a single computational device that is useable before a surgical procedure and during the surgical procedure. In other words, two or more computational devices are not a requirement of the system 100, but rather are illustrated to show that different computational devices may be used by the care provider 108 during different phases of planning a surgical procedure.

The imaging system 124 may include one or more image capture devices 128 that are configured to capture images of the patient 104 or patient anatomy. In some embodiments, the image capture devices 128 are configured to capture images of patient anatomy within a field of view 132. As an example, the image capture devices 128 may be operable to image anatomical features (e.g., a bone, veins, soft tissue, etc.) and/or other aspects of patient anatomy to yield image data (e.g., image data depicting or corresponding to a bone, veins, soft tissue, etc.). “Image data” as used herein refers to the data generated or captured by an image capture device 128, including in a machine-readable form, a graphical/visual form, and in any other form. In various examples, the image data may comprise data corresponding to an anatomical feature of a patient, or to a portion thereof. The image data may be or comprise a preoperative image, an intraoperative image, a postoperative image, or an image taken independently of any surgical procedure.

In some embodiments, an image capture device 128 may be capable of taking a 2D image or a 3D image to yield the image data. The image capture device 128 may be or comprise, for example, any device utilizing X-ray-based imaging (e.g., a fluoroscope, a CT scanner, or other X-ray machine), a Magnetic Resonance Imaging (MRI) scanner, an ultrasound imaging device, an optical coherence tomography (OCT) scanner, an endoscope, a microscope, an optical camera, a thermographic camera (e.g., an infrared camera), a radar or LIDAR system (which may comprise, for example, a transmitter, a receiver, a processor, and one or more antennae), or the like. The image capture device 128 may be contained entirely within a single housing, or may comprise a transmitter/emitter and a receiver/detector that are in separate housings or are otherwise physically separated.

In some embodiments, the imaging system 124 may include more than one image capture devices 128. The imaging system 124 is capable of obtaining images of patient anatomy in the form of image data, then providing the images to the computational devices 116, 120, where one or more objects or models of patient anatomy may be uploaded into a CAD environment. For instance, images captured with the imaging system 124 may be used to generate one or more models of patient anatomy that can then be visualized and manipulated within a CAD tool executed on the computational device 116, 120. As a more specific, but non-limiting example, the CAD tools executed on the computational device 116, 120 may be configured to generate and manipulate a model of patient anatomy (e.g., hard tissue including but not limited to osseous matter, soft tissue including but not limited to gingiva, combinations of hard/soft tissue, etc.) as will be described in further detail herein.

The surgical tools 136 may include any number of known or yet-to-be developed surgical instruments. In some embodiments, the surgical tools 136 may include handheld tools that are useable by the care provider 108 during the surgical procedure. Examples of such tools include, without limitation, drills, scissors, blades, knives, scalpels, resectors, retractors, implants, portions of implants, implant kits, surgical guides, screws, sutures, etc. The surgical tools 136 may alternatively or in addition include robotic surgical tools or robotic surgical systems. For instance, the surgical tools 136 may include a surgical robot that helps the care provider 108 perform a surgical procedure either semi-autonomously or fully-autonomously.

The manufacturing system 140 may be configured to create, in real-time (e.g., during a surgical procedure, including optionally simultaneously or substantially simultaneously), surgical tools 136. For example, the manufacturing system 140 may interact with CAD tools provided by the computational device 116, 120 to create surgical implants, prosthetics and associated support structures, surgical guides, stacked surgical guides, or the like. The manufacturing system 140 may be co-located with the table or chair 112 or may be located remotely from the table or chair 112. As a non-limiting example, the manufacturing system 140 may include a three-dimensional (3D) printer, a Computer Numerical Control (CNC) machine, a turning machine, a shaper/planer, a drilling machine, a milling machine, a grinding machine, a power saw, a press, a lamination machine, or a combination thereof.

The manufacturing system 140 may be configured to receive one or more electronic files from a computational device 116, 120 and manufacture an object in accordance with dimensions of the object defined within the electronic file. As a non-limiting example, the manufacturing system 140 may include a 3D printer that is configured to produce a surgical guide or collection of surgical guides during a surgical procedure in accordance with object data received from a computational device 116, 120. The surgical guide or collection of surgical guides may be produced during a surgical procedure based on images captured of the patient 104 while on the table or chair 112 (e.g., while sedated for the surgical procedure). The manufacturing system can also produce dental restoration systems and components thereof.

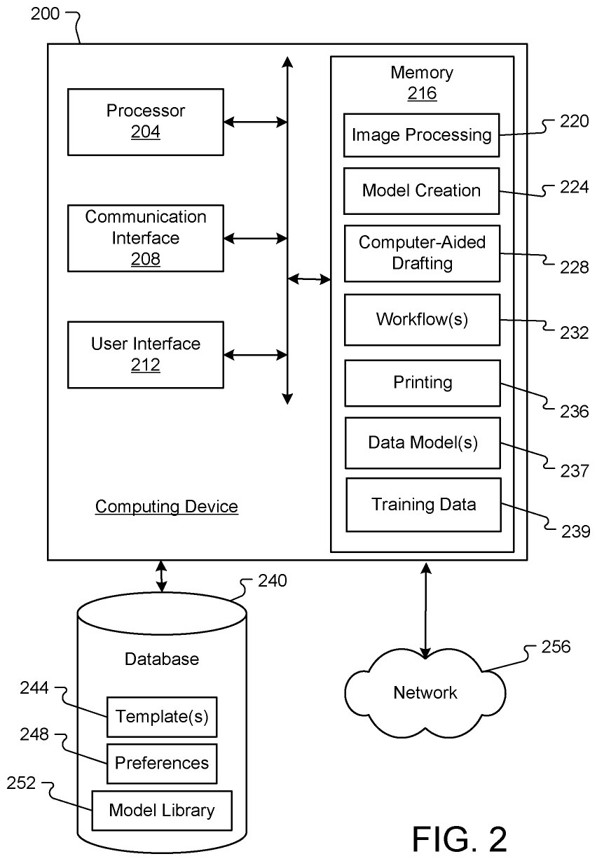

With reference now to FIG. 2, additional details of a computing device 200 will be described in accordance with at least some embodiments of the present disclosure. It is noted that the computing device 200 may correspond to an example of the computational device 116 and/or computational device 120, for purposes of the present disclosure.

The computing device 200 is shown to include one or more of a processor 204, a communication interface 208, a user interface 212, and memory 216. The computing device 200, in some embodiments, is interconnected with a database 240 and a broader communication network 256.

The processor 204 of the computing device 200 may be any processor described herein or any similar processor. The processor 204 may be configured to execute instructions or machine learning models (e.g., neural networks, decision trees, etc.) stored in the memory 216 (e.g., data), which may cause the processor 204 to carry out one or more computing steps. Illustratively and without limitation, the processor 204 may be configured to provide CAD tools to a user of the computing device 200 when executing contents of the memory 216.

The memory 216 may be or comprise RAM, DRAM, SDRAM, other solid-state memory, any memory described herein, or any other tangible, non-transitory memory for storing computer-readable data and/or instructions. The memory 216 may store information or data useful for completing, for example, any step of the methods or workflows described herein. The memory 216 may store, for example, one or more image processing algorithms 220, model creation functions 224, CAD tools 228, CAD workflows 232, data models 237, training data 239, and/or printing functions 236. Such instructions, data, or algorithms may, in some embodiments, be organized into one or more applications, modules, packages, layers, or engines. The algorithms, data, and/or instructions may cause the processor 204 to manipulate data stored in the memory 216 and/or received from or via the imaging system 124, the database 240, and/or the communication network 256.

The image processing 220, when executed by the processor 204, may enable the computing device 200 to cooperate with the imaging system 124 to obtain and use images of the patient 104 or patient anatomy. In some embodiments, the image processing 220 may be configured to receive patient images (e.g., preoperative patient images, intraoperative patient images, and/or postoperative patient images), receive object images, etc., and prepare the images for processing by other components of the computing device 200. Illustratively, the image processing 220 may be configured to receive image data and format the image data for consumption by the model creation functions 224 and/or CAD tools 228. In some embodiments, the image processing 220 may be configured to transform an image or image data into a different consumable format by converting the image from one digital format to another digital format, by performing pixel analysis to determine locations or boundaries of objects, by identifying locations of fiducials in an image, by compressing an image, by decompressing an image, by overlaying object models on an image, and/or any other task associated with preparing an image for consumption by the model creation functions 224 for use by the CAD tools 228.

The model creation functions 224 is shown as being separate from the CAD tools 228, but may be incorporated into the CAD tools 228. In some embodiments, the model creation functions 224 is configured to convert image data from the image processing 220 into one or more models of an anatomical element. For instance, the model creation functions 224 may be configured to generate an object within the CAD tools that represents the physical dimensions of an anatomical part of the patient 104. As a more specific but non-limiting example, the model creation functions 224 may be configured to generate an electronic file representing anatomy of a patient (e.g., gingiva, teeth, mandibular jawbone, elements of the mandible, maxillary bone, elements of the maxilla, nerves, soft tissue, etc.). The objects or models created by the model creation functions 224 may be viewable and capable of manipulation with the CAD tools 228.

To create a prosthesis, the dental region of the patient 104 may be placed within the field of view 132 and scanned, as described above. Alternatively or in addition, the model creation functions 224 may use other inputs to generate an electronic file representing the anatomy of the patient 104. For instance, the model creation functions 224 may be configured to generate models using one or more of a stone model made from impression material, laser scanning techniques, a photographic scanning technique, or a mechanical sensing technique. Alternatively or in addition, the care provider 108 can photograph implants and other components that have been placed into or adjacent the mouth of the patient 104. The model creation functions 224 may also be configured to accurately relate the gingival margin for all mold, model, implant and abutment dimensions.

The CAD tools 228 may be configured to allow visualization and manipulation of objects within a CAD environment. For instance, the CAD tools 228 may enable a visualization of patient 104 anatomy as well as possible implants to be placed within the patient 104 anatomy. Additional capabilities and features of the CAD tools 228, including optionally with the imaging system 124 and/or a projecting system 724 will be described in further detail herein.

The workflows 232 may represent various guides for steps to be taken with the CAD tools 228. Although depicted as separate from the CAD tools 228, it should be appreciated that the workflows 232 may be provided as part of the CAD tools 228. In some embodiments, the workflows 232 represent an ordered series of steps to take within the CAD environment as the care provider 108 manipulates the objects with the CAD tools 228. Workflows 232 may include prosthesis design/creation/placement/planning, surgical guide creation, bone graft planning, incision planning, drill planning, etc.

The printing functions 236 may correspond to an Application Programming Interface (API) that facilitates communication between the CAD tools 228 and the manufacturing system 140. In some embodiments, the printing functions 236 functionality enables one or more objects in the CAD environment to be produced via the manufacturing system 140. As a more specific example, the printing functions 236 functionality may generate one or more electronic files that describe physical dimensions of an object (or multiple objects) in the CAD environment along with instructions for the manufacturing system 140 to accurately produce/replicate the object using an appropriate manufacturing technique (e.g., 3D printing).

In an embodiment, the data models 237 are capable of predicting the volume, contour and/or location of objects corresponding to one or more anatomical features in the images of the patient 104 or patient anatomy, including by not limited to teeth and roots thereof, bone or other osseous structures in the jaw, mandibular nerves or root canal, and soft tissue features such as gingiva, muscles, blood vessels, and the like. Compared to conventional CAD software for dental applications, the care provider would be required to use CAD tools to manually segment and categorize or identify the imaged information surface-by-surface and object-by-object. This process is laborious, time-consuming, and potentially inaccurate. In contrast, the data models 237 can automatically segment the surfaces without user involvement, such as automatically identifying the gingiva, nerves, root canals, bone or bony or osseous structure, blood vessels and the like. When the various anatomical features and objects are identified, the data models can create protection areas, such as root canals/nerves and blood vessels, that are avoided by the implant, surgical guide, and other dental restoration components during CAD designing.

In an embodiment, the data models 237 are capable of predicting or recommending, without user involvement or guidance, an optimal crown object configuration or model for a given tooth like object and assign a corresponding identifier (e.g., a unique number under the Universal Numbering System, Palmer Notation Method, or FDI World Dental Federation Notation) of the tooth-like object (e.g., tooth) to the autogenerated crown object. The data model is able to autogenerate the crown objects in the areas of the jaw that are missing teeth taking into account both the dimension and the occlusion, automatically select the implant objects from an implant library or use an implant object selected from the library by a care provider (discussed below) and position the implant objects substantially optimally in view of the available bone structure. The CAD workflows that are performed by a data model to autogenerate the crown object and abutment object are described below.

In an embodiment, the data models 237 are capable of predicting or recommending, without user involvement or guidance, an abutment object configuration or model (e.g., healing or permanent abutment) configuration for an autogenerated crown object for a given tooth like object. The data model is able to auto select the abutment object from an abutment library or use an abutment object selected by a care provider from the library (discussed below), optionally design the emergence profile, and design the abutment and crown objects to engage each other. The CAD workflows that are performed by a data model to autogenerate the abutment object and interface between the abutment object and crown object are described below.

In an embodiment, the data models 237 are capable of predicting or recommending, without user involvement or guidance, a bone graft object configuration or model (e.g., corresponding to a bone graft) for the areas of the jaw that are missing teeth and require additional bone growth to support an implant with sufficient strength to resist masticatory forces. The CAD workflows that are performed by a data model to autogenerate the bone graft object are described below.

In an embodiment, the data models 237 are capable of predicting or recommending, without user involvement or guidance, the various object configurations or models (e.g., corresponding to a crown, inlay, onlay, bar structure and associated attachment and locator members, artificial teeth, abutment, and bone graft), for a permanent or temporary dental restoration model (e.g., corresponding to an inlay or onlay, a dental bridge, a dental implant, a full, partial, immediate, or other implant-retained or supported overdenture), or other restorative dentistry component or system. The data model could present the care provider or patient with various restoration options such as designing and recommending a series of crowns and implants, designing and recommending a hybrid overdenture, designing and recommending a single overdenture, and designing and recommending a surgical guide. The care provider can further provide constraints, such as budget, patient restoration preferences, the care provider's design preferences, and the like. Based on the selected option, the data model autogenerates and recommends one or more dental restoration models for consideration. The various dental restorations and components thereof and associated workflows that are performed by a data model to autogenerate a dental restoration model are described in the workflow below.

In an embodiment, the data models 237 are capable of receiving a dental restoration model and work backwards to select and configure each dental restoration component to be compatible with the dental restoration model. For example, the care provider can design a CAD model of a full or partial overdenture and the data model is configured to design the bar structure or prosthetic object and associated attachment and connector member objects to engage and secure the full or partial overdenture to the jaw of the patient. In another example, the gingiva margin line is determined based on the intersection of the crown object with the gingiva object and a custom abutment object is auto-generated by the data model such that the emergence profile on the custom abutment object matches the intersection and the post and outer lip of the abutment object engage the associated crown object. The CAD workflows that are performed by the data model are discussed in detail below.

In an embodiment, the data models 237 are capable of receiving images of persistent points of reference defined by devices 606 and generating a coordinate system based on the persistent points of reference. The data models 237 are capable of modifying the coordinate system, based on CAD workflows on the coordinate system, adjusting or modifying CAD models that are generated using or by the CAD workflows based on the coordinate system, and other actions to maintain alignment of the defined coordinate system throughout the various stages of a dental restoration process.

The data models 237 can be any self-evolving, artificial intelligence (AI)-based models (also referred to as self-learning, AI-based models), whether using supervised, unsupervised, or reinforcement learning methods, machine learning, deep learning, generative AI, computer vision or hybrid models, functions or capabilities or narrow AI, general AI, or super AI in scope. Common models include linear regression, decision trees, and deep neural networks.

The data models can, for example, use computer vision and deep learning to detect anatomical patterns and features. In an embodiment, the data model first pre-processes the image data or model thereof to improve clarity, resolution, and legibility, such as by normalizing pixel values of the image information (e.g., adjusting the intensity range) based on the acquisition metadata to ensure consistent interpretation. The pre-processed image data or model thereof is processed layer by layer using a non-linear predictive control technique, such as a convolutional neural network (CNN) (e.g., neural network designed to detect patterns in images (such as edges, shapes and textures)). The first layers of the CNN detect simple patterns, like edges and textures, while the later layers delve into more complex anatomical cues that help the model spot anatomical structures. The data model, using the information collected and/or based on training data, classifies each identified anatomical structure in the pre-processed image data or model thereof (e.g., tooth, gingiva, bony or osseous structure, root canal, nerve, blood vessel, and the like) such as with bounding boxes. In some cases, a model may generate a probability score to show the confidence in the categorization. Next, the data model may overlay the findings on the image data or model thereof. This can be with bounding boxes, explainability tools or heatmaps, providing transparency into why the AI made the decision. The care provider can then use these visual tools to verify or challenge the results from the data model.

In an embodiment, the 2D or 3D scan data is converted into a 3D CAD model as part of the pre-processing process and the CNN is applied to the CAD model. The conversion can be done using reverse engineering software, such as Geomagic Design X™, FreeCAD™, Scan2CAD™, Dassault Systemes Catia™, Autodesk Fusion 360™, Geomagic for Solidworks™, Siemens NX™, Ansys Spaceclaim™, Tebis™, Meshmixer™, and Mesh2Surface™, among others. In one non-limiting example, an original 2D or 3D scan (typically in STL format) is loaded into the reverse engineering software. A CAD model (typically in STEP format) is generated by designing it on top of the underlying geometry of the 3D scan. In some embodiments, raster pixels in the image data are converted into lines, shapes, curves and dimensions defining the CAD model.

Training of the data models may train a baseline data model. For example, the training data may comprise pre-restoration image data and models and respective dental restoration models that are used to train the baseline model. The training data may or may not be associated with one or more care providers or specialists. In the latter case, the trained baseline model would reflect the preferences and dislikes of the associated one or more care providers or specialists. Training is performed by first performing segmentation manually (e.g., using a virtual brush painting technique) and then doing the segmentation by the data model. The manual segmentation is compared with the data model segmentation to determine a set of differences. For instance, the STL or sterolithography file is compared with a DICOM file, or image file compliant with part 10 of the DICOM standard, to determine the set of differences. This can be done for mandibular nerve detection, automatic bone segmentation, with or without teeth, panoramic curve reconstruction, automatic extraction of toothlike objects from the image data or model, and automatic crown object extraction from the image data or model. If the differences exceed a predetermined threshold, the hyperparameters and other parameters of the data model are adjusted to reduce the magnitude of the differences.

In some embodiments, the CAD tools 228 and data models may operate with assistance of data from the database 240. Examples of data that may be stored in database 240 and may be used by the CAD tools 228 include templates 244, preferences 248, and a model library 252. While illustrated as being in a separate database 240, it should be appreciated that some or all of the elements shown in the database 240 could be included in memory 216 without departing from the scope of the present disclosure.

The templates 244 and/or model library 252 may include one or more electronic files describing objects for use by the CAD tools 228. In some embodiments, objects may be created or manipulated within the CAD environment, then the objects may be saved as templates 244 for later use in a different surgical procedure. For instance, a care provider 108 may create one or more templates that can be slightly adjusted or customized for use with different patients. Objects can be loaded into the CAD environment by the CAD tools 228 using the templates 244. Similarly, presentation and application preferences for the CAD tools 228 may be maintained and referenced as part of the preferences 248. The preferences 248 may correspond to one or more values or settings used at an application level by the CAD tools 228. The preferences 248 may be changed, saved, or reset by the care provider 108.

The model library 252 may include one or more templates 244. In some embodiments, however, the model library 252 may store electronic files for models or objects to be used during a surgical procedure. As an example, the model library 252 may include files describing physical dimensions of implants or implant kit components. The dimensions of the objects stored in the model library 252 may be defined by the manufacturer of the implants. Objects loaded from the model library 252 may or may not be adjustable or have control points that facilitate an adjustment of relative dimensions by the CAD tools 228 whereas objects loaded from the templates 244 may be adjustable or have control points that facilitate an adjustment of relative dimensions by the CAD tools 228.

The communication interface 208 may be used for receiving image data or other information from an external source (such as the imaging system 124, the database 240, the network 256, and/or any other system or component not part of the system 100). The communication interface 208 may provide connectivity between the computing device 200 and the communication network 256, thereby enabling machine-to-machine communication with other devices of the system 100. The communication interface 208 may comprise one or more wired interfaces (e.g., a USB port, an ethernet port, a Firewire port) and/or one or more wireless transceivers or interfaces (configured, for example, to transmit and/or receive information via one or more wireless communication protocols such as 802.11a/b/g/n, Bluetooth, NFC, ZigBee, and so forth). In some embodiments, the communication interface 208 may be useful for enabling the computing device 200 to communicate with one or more other processors or computing devices 200, whether to reduce the time needed to accomplish a computing-intensive task or other reason.

The user interface 212 may be or comprise a keyboard, mouse, trackball, monitor, television, screen, touchscreen, and/or any other device for receiving information from a user and/or for providing information to a user. The user interface 212 may be used, for example, to receive a user selection or other user input regarding any step of any method described herein. Although the user interface 212 is shown as part of the computing device 200, in some embodiments, the computing device 200 may utilize a user interface 212 that is housed separately from one or more remaining components of the computing device 200. In some embodiments, the user interface 212 may be located proximate one or more other components of the computing device 200, while in other embodiments, the user interface 212 may be located remotely from one or more other components of the computing device 200. Illustratively, the user interface 212 may include a user input device, a user output device, and a combination user input/user output device (e.g., a touch-sensitive display device).

It is noted that exemplary workflows 232 and/or data models 237, including optionally for use with CAD tools 228, are described in U.S. patent application Ser. No. 19/573,963, incorporated herein by reference in the entirety. The workflows and capabilities as shown and described in the present application may be in a particular order, but it should be appreciated that the CAD tools 228 can be configured to enable the order of operations in any particular workflow to be changed, skipped, modified, or the like. More specifically, the CAD tools 228 are flexibly configured to allow the care provider 108 to take any step or combination of steps in any order desired. The illustrated steps are shown for purposes of illustration and should not be construed as limiting embodiments of the present disclosure.

The various workflows and capabilities of the CAD tools 228 can enable any created or edited object to be saved as a selected object or combination of objects as a template 244 or into the model library 252. The workflows allow the user is allowed to name the objects currently selected within the CAD environment as a new template 244 or object in the model library 252.

In addition to providing the ability to create new objects, the various workflows may also facilitate the importation of an object into the CAD environment from a template 244 or the model library 252. As discussed throughout the present disclosure, libraries of objects may be provided to enable users to view or browse some or all of the objects that have been saved as a template 244 or object in the model library. An object selected from the slot library may be imported into the CAD environment for manipulation relative to other objects already imported into the CAD environment. The object, when initially imported, may have all of the dimensions and control points that existed when the object was created or saved; however, it may be possible to customize the dimensions of the object once imported into the CAD environment. For example, a selected object imported from the object library may have multiple control points that can be adjusted to realize a new freeform object.

In addition to facilitating the creation of customized object via use of cut-type objects, embodiments of the present disclosure also contemplate that freeform objects can be added or merged with other objects in the CAD environment. For instance, a workflow may merge one or more objects to arrive at a resultant object. The objects may have one or more control points that are movable in three dimensions. A presentation of the objects in an overlapping arrangement can be shown even while the user manipulates and adjusts a position of control points, thereby changing a size of one or more objects. Eventually, a merge function may be performed using one or more Boolean operations, thereby combining the two separate objects into a resultant object that occupies the volumes and has the shapes of the previously separated objects.

In at least some workflows, an object may be duplicated or imported into the CAD environment multiple times. Each portion (e.g., volume) of overlap, where any overlap exists, between an object and another object may be determined. The overlapping volumes may then be subject to a Boolean operation in which the overlapping volumes are subtracted, removed, or otherwise adjusted into a split volume. Alternatively, the objects may be merged or combined in the CAD environment. In some embodiments, objects may only be merged with another object of a particular type. For example, but without limitation, objects may only be eligible for merging with other non-anatomical objects. Thus, when a merge function is selected, only the objects eligible for merger with the object may remain displayed while other objects not eligible for merger with the object are removed from view.

It should be appreciated that a greater or lesser number of objects can be presented simultaneously in a CAD environment (e.g., on a graphical user interface) such that relative dimensions of various objects can be visualized for purposes of planning a surgical procedure or dental restoration. The objects can correspond to a patient feature or man-made object. The objects representing anatomical features of the patient 104 may include hard tissue objects (e.g., bones, teeth, etc.) or soft tissue objects (e.g., nerves, arteries, gingiva, tongue, etc.). The objects representing man-made objects may include prosthetics, implants, abutments, bar structures, screws, surgical guides, stacked surgical guides, alignment mechanisms, fasteners, or the like. In addition, it is noted that the GUI may include toolbars with selectable tools for object manipulation or adjustment, and/or may include or define control points and/or intervening boundaries within the CAD environment that can be independently or globally adjusted in one, two, or three dimensions for one or more objects.

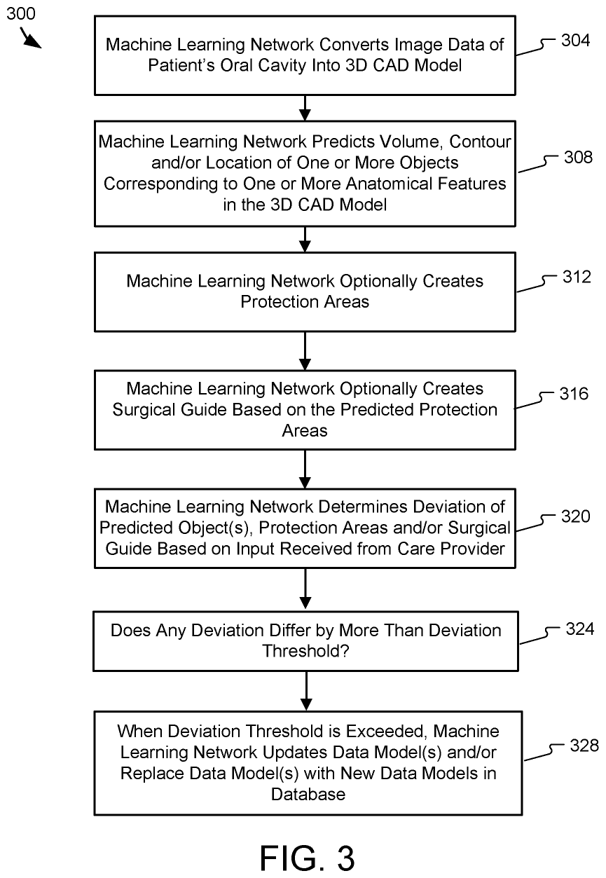

With reference now to FIGS. 3-5, various machine learning network methods and will be described in accordance with at least some embodiments of the present disclosure, including optionally being associated with generating, training, and applying self-evolving AI-based behaviors described herein, and may be performed by one or more components of a system 100 or computing device 200. In the following description of the process flows 300, 400, and 500, the operations may be performed in a different order than the order shown, or the operations may be performed in different orders or at different times. Certain operations may also be left out of the process flow, or other operations may be added to the process flow. It is to be understood that any computational device as described throughout the present disclosure may perform the operations shown. The machine learning networks referenced in the process flows each correspond to one or more of the data models 237.

Referring to FIG. 3, the process flow 300 is initiated by the machine learning network converting 304 image data of an oral cavity of the patient into a 3D CAD model.

In embodiments, the process flow 300 may include the machine learning network making 308 a series of predictions, each with an associated probability of accuracy, regarding the volume, contour, and/or location of one or more objects corresponding to one or more anatomical features in the 3D CAD model. The one or more objects may be, for example, nerves, nerve canals or pathways, blood vessels, blood vessel pathways, and the like).

In embodiments, the process flow 300 may include the machine learning network optionally creating 312 one or more protection areas for anatomical feature objects predictions having at least a threshold probability or likelihood of accuracy. As will be appreciated, the protection areas indicate areas or volumes of the 3D CAD model of the oral cavity of the patient that are off-limits or to be avoided by invasive surgical incisions (e.g., drill holes) or tools (e.g., drill bits and implants). A safety margin or factor may be used to expand the area or volume of the predicted location to further reduce the likelihood that the identified anatomical feature object is within the protection zone.

In embodiments, the process flow 300 may include by the machine learning network optionally creating 316 a plurality of surgical guide objects, each having an associated probability of being the optimal design, based on one or more predicted protection areas. The surgical guide objects selected for review by the care provider satisfying at least a threshold probability. As will be appreciated, a surgical guide object corresponds to a surgical guide that typically is a custom-made, 3D-printed, or milled template that fits over teeth, gums, or bone of a patient to precisely direct the location, depth, and angle of drill hole and implant placement. The guide may rest on teeth, mucosa, or bone, depending on the application. A typical surgical guide is made of resin and includes metal sleeves (or bushings) providing holes or pathways to guide the drill and place the implant. The thickness of the surgical guide may initially be generated with substantial conformity to the surface of the object or model of the oral cavity of the patient. As with other objects in the CAD environment, the surgical guide may initially be created by manipulating a plurality of control points by selecting the contact surface on the anatomy surface of the oral cavity of the patient.

In embodiments, the process flow 300 may include the machine learning network monitoring 320 editorial input from (or modifications by) the care provider not only as to which anatomical feature prediction and surgical guide object design is selected by the care provider but also the care provider's changes to the type, location, boundary, orientation, dimensions, and volume of each selected object corresponding to an anatomical feature or protection area and/or surgical guide object design. Further deviations can result from the care provider selecting an anatomical feature prediction and surgical guide object design having an associated lower likelihood or probability of being an accurate or optimal solution, respectively.

In embodiments, the process flow 300 may include the machine learning network determining 324 if the magnitude of any deviation, change or modification exceeds a respective deviation threshold.

In embodiments, for each change or modification for which the associated magnitude exceeds a respective deviation threshold, the process 300 may include the machine learning network updating 328 the data model by changing one or more model parameters or hyperparameters and/or replaces the data model with a new data model in the database. As will be appreciated, each type or category of change or modification and each object changed or modified may have a different deviation threshold reflecting the relative importance of the object to a successful outcome for the patient.

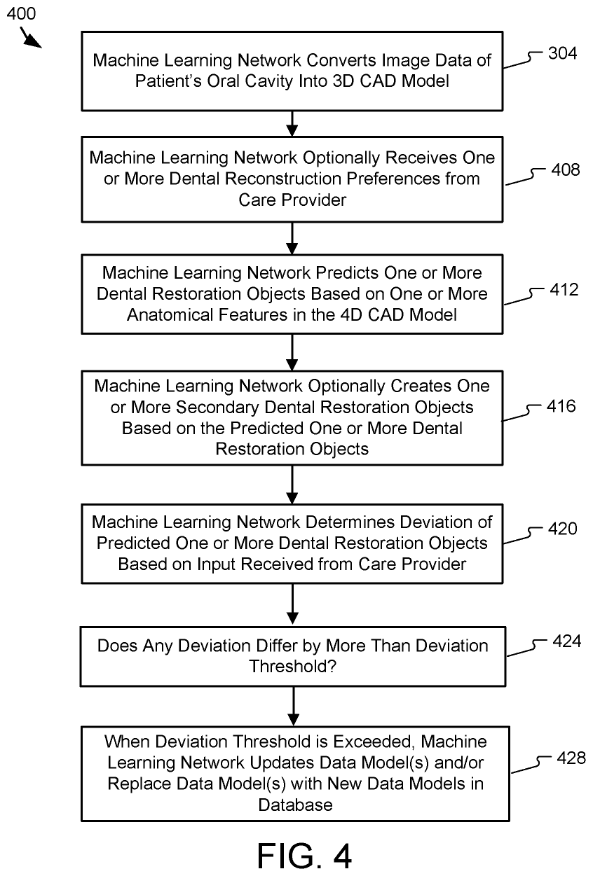

Referring to FIG. 4, the process flow 400 is initiated by the machine learning network converting 304 image data of an oral cavity of the patient into a 3D CAD model.

In embodiments, the process flow 400 may include the machine learning network optionally receiving 408 one or more dental reconstruction preferences from a care provider. The preferences can include the type and/or minimum or maximum cost of dental restoration. Types of dental restorations include, for example, crowns or caps, bridge, dental implant with prosthetic tooth-like structures, inlays, onlays, removable or permanent overdentures, dental bonding, and veneers. Other preferences include type or model of implant, healing or permanent abutment, attachment member, locator member, sleeve and whether the components are to be stock or custom designed.

In embodiments, the process flow 400 may include the machine learning network predicting 412 and creates 416, based on the preferences and one or more anatomical features in the 3D CAD model, a plurality of sets of one or more dental restoration objects or models, each having an associated probability of being the optimal solution. The set of dental restoration objects or models include not only the visible dental restoration objects, such as the crown, overdenture, prosthetic tooth, and the like but also the less visible dental restoration objects (or secondary objects), such as objects corresponding to the dental implants, healing or permanent abutment, attachment member, cap, locator member, bar structure, bonding mechanism, bone graft, and the like. The predicted or recommended sets of one or more dental restoration objects or models includes the locations, orientations, volumes, and dimensions of each object or model. In an embodiment, the machine learning network performs one or more of the workflows described above to provide each predicted or recommended set of dental restoration objects and/or models. The one or more anatomical features in the 3D CAD model can be identified, located, and dimensionally and volumetrically quantified using the process flow 300.

In embodiments, the process flow 400 may include the machine learning network monitoring 420 editorial input from (or modifications by) the care provider to the which set of one or more dental restoration objects or models is selected by the care provider but also to the type, location, boundary, orientation, dimensions, and volume of each dental restoration object in the selected set of dental restoration objects. A further deviation results from the care provider selecting a set of one or more dental restoration objects or models having an associated lower likelihood or probability of being an optimal solution.

In embodiments, the process flow 400 may include the machine learning network determining 424 if the magnitude of any deviation, change or modification to the selected set exceeds a respective deviation threshold.

In embodiments, for each change or modification for which the associated magnitude exceeds a respective deviation threshold, the process flow 400 may include the machine learning network updating 428 the parameters or hyperparameters of the data model and/or replaces the data model with a new data model in the database. As will be appreciated, each type or category of change or modification and each object changed or modified may have a different deviation threshold reflecting the relative importance of the object to a successful dental restorative outcome for the patient.

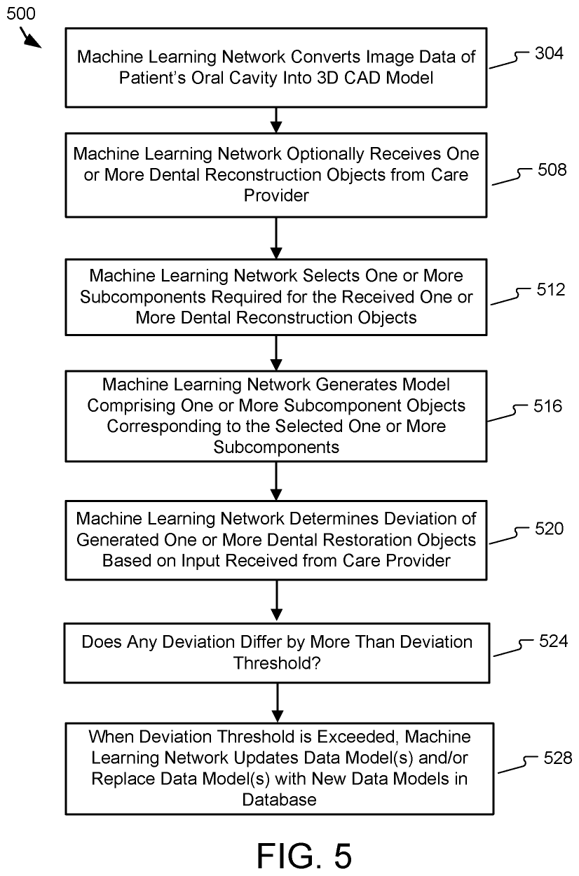

Referring to FIG. 5, the process flow 500 is initiated by the machine learning network converting 304 image data of an oral cavity of the patient into a 3D CAD model.

In embodiments, the process flow 500 may include the machine learning network receiving 508 one or more dental restoration objects or models from a care provider. Types of dental restoration objects include, for example, crowns or caps, bridge, dental implant with prosthetic tooth-like structures, inlays, onlays, removable or permanent overdentures, dental bonding, and veneers. In one application, the one or more dental restoration objects or models include a model of the visible portions of the dental restoration, such as an aesthetic appearance of a crown, prosthetic tooth, overdenture, or other restoration.

In embodiments, the process flow 500 may include the machine learning network selecting 512 different sets of one or more subcomponents required for a dental restoration comprising the received one or more dental restoration objects. Each set having an associated likelihood or probability of being an optimal solution. The selection of each set may be based on an identified anatomical feature of the patient, care provider preference, and the like. The selection, for example, could include any of the selection process and options referenced in the workflows above. For example, a template 244, preference 248 or model library 252 may be used as the basis for the selection process. The one or more subcomponents can, for example, be an implant, healing or permanent abutment, sleeve, cap, attachment member, locator member, and/or bar structure.

In embodiments, the process flow 500 may include the machine learning network generating 516 a plurality of dental restoration models, each having an associated likelihood or probability of being an optimal solution. The plurality of dental restoration models can, in some embodiments, be based only on those sets of one or more subcomponents in the selecting 512 having at least a threshold likelihood of being the optimal selection. Each dental restoration model typically includes not only one or more subcomponent objects corresponding to the selected one or more subcomponent objects but also the received one or more dental reconstruction objects. As an example, each model can not only common visible dental restoration objects, such as the crown, overdenture, prosthetic tooth, and the like but also different ones of the less visible dental restoration objects (or secondary objects), such as objects corresponding to the dental implants, healing or permanent abutment, attachment member, cap, locator member, bar structure, bonding mechanism, bone graft, and the like. The predicted or recommended model of include the locations, orientations, volumes, and dimensions of each subcomponent object or model. In an embodiment, the machine learning network performs one or more of the workflows described above beginning at a desired visible dental restoration outcome and working in reverse fashion to provide each predicted or recommended set of dental restoration objects and/or models.

In embodiments, the process flow 500 may include the machine learning network monitoring 520 editorial input from (or modifications by) the care provider not only as to which of the plurality of dental restoration models is selected but also to the type, location, boundary, orientation, dimensions, and volume of each dental restoration object in the selected set of dental restoration objects. A further deviation results from the care provider selecting a dental restoration model having an associated lower likelihood or probability of being an optimal solution.

In embodiments, the process flow 500 may include the machine learning network determining 524 if the magnitude of any deviation, change or modification exceeds a respective deviation threshold.

In embodiments, for each change or modification for which the associated magnitude exceeds a respective deviation threshold, the process flow 500 may include the machine learning network updating 528 the parameters or hyperparameters of the data model and/or replaces the data model with a new data model in the database. As will be appreciated, each type or category of change or modification and each object changed or modified may have a different deviation threshold reflecting the relative importance of the object to a successful dental restorative outcome for the patient.

While the various aspects and embodiments of the disclosure are discussed with reference to CAD, it is to be appreciated that aspects and embodiments can be used with other software used for computer creation, modification, analysis, and/or optimization of a design. Additionally, other versions of CAD may be used with the aspects and embodiments, including 2D CAD, 3D CAD, and freeform CAD.

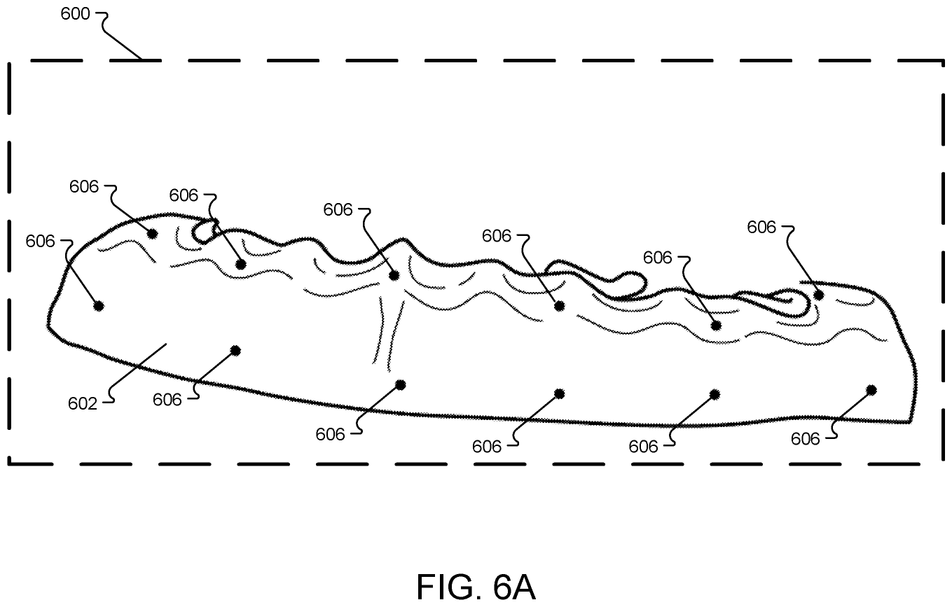

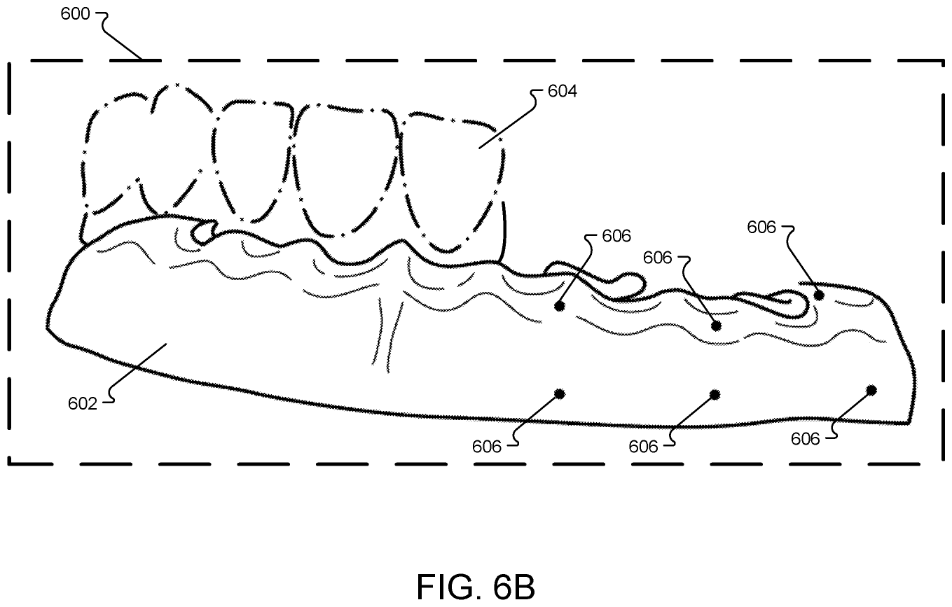

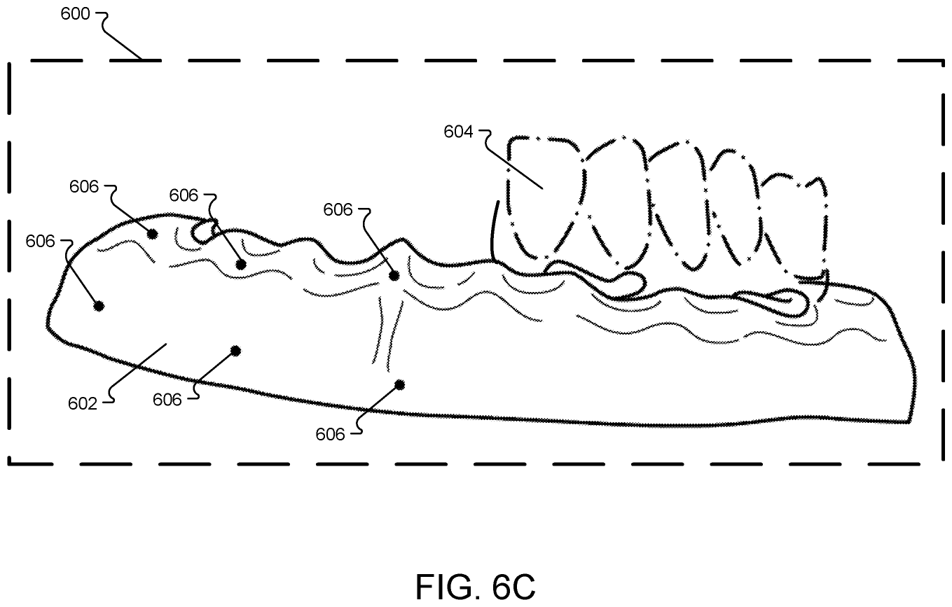

FIGS. 6A-8 generally illustrate the defining of coordinate systems within the mouth 600 of the patient, and use of the same in virtual reality and/or augmented reality applications, in accordance with one or more embodiments of the present disclosure.

It is noted that the defining of coordinate systems may be accomplished with one or more of the system 100 of FIG. 1 and/or the computing device 200 of FIG. 2, and/or may be accomplished with alternative or supplemental components for the system 100 of FIG. 1 and/or for the computer device 200 of FIG. 2, without departing from the scope of the present disclosure. In addition, it is noted that the defining of coordinate systems may be accomplished when performing (or parallel with the performing of) one or more operations of the methods in FIGS. 3-5, without departing from the scope of the present disclosure. Further, it is noted that the defining of coordinate systems illustrated in FIGS. 6A-6C may be usable with any of the workflows and/or process flows as described in U.S. patent application Ser. No. 19/573,963, incorporated herein by reference in the entirety.

FIG. 6A illustrates the gingiva 602 of the lower jaw (or mandible) prepared for a full dental restoration in the mouth 600, with no teeth 604 remaining. In addition, FIG. 6B illustrates the gingiva 602 of the mandible with a first subset of teeth 604 (e.g., proximate to the front of the mouth 600) remaining, for installation of a partial dental restoration in the rear of the mouth 600. Further, FIG. 6C illustrates the gingiva 602 of the mandible with a second subset of teeth 604 (e.g., proximate to the rear of the mouth 600) remaining, for installation of a partial dental restoration in the front of the mouth 600.

In general, however, it should be understood that the defining of coordinate systems may be used for any configuration of partial or full dental restoration to be installed within the mouth of the patient, including optionally single teeth, without departing from the scope of the present disclosure. In addition, it should be understood that the defining of coordinate systems may be used for designing a partial or full dental restoration for the mandible and/or the maxilla in the mouth 600 of the patient, without departing from the scope of the present disclosure.

In embodiments, one initial stage of the design and installation process for dental restorations includes the acquiring of scan data of the gingiva 602 (and optionally any teeth 604 to remain post-installation of the dental restorations) in the mouth 600 of the patent. For example, the acquired scan data may provide a coordinate system which may be utilized to design and/or install dental restorations. Where multiple (or all) teeth 604 are in need of replacement, defining coordinate systems within the mouth 600 for the designing and installation of the dental restoration is difficult as there is a reduced ability to rely on the gingiva 602, which is a less stable surface within the mouth 600 as compared to the teeth 604. However, even where teeth 604 remain within the mouth 600 with the installation of partial dental restorations, micro-movements may occur in the mandible and/or maxilla of the patient which may cause a shifting of the coordinate system being used for the designing and installation process.

In addition, scanning directly on the gingiva 602, including during intra-oral scanning such as a cone beam computed tomography (CBCT) scanning and/or which may require one or more of the image capture devices 128 as illustrated in FIG. 1, may be painful for the patient. Scannable devices such as, but not limited to, scan trees or other implants that are installable within the mouth 600 of the patient can be overly invasive. In some instances, the installation of the scannable devices (e.g., during drilling or other operations needed to install the scannable device within the gingiva 602) may interfere with nerves below the gingiva 602 and within the mouth 600 of the patient, causing (potentially) serious injury or death of the patient.

As such, a coordinate system is desirable that relies upon installations with reduced-or minimal-invasiveness within the mouth 600. The installations may be relied upon throughout the dental restoration process, to provide persistent points of reference for defining a coordinate system within the mouth 600 and/or adjusting or re-establishing the coordinate system when movement of the gingiva 602 (or, more generally, micro-movements of or in the mouth 600) occurs.

In embodiments, one or more devices 606 are installed within the gingiva 602. For example, the one or more devices 606 may be installed at one or more locations within the gingiva 602, to define coordinates in one, two, or three dimensions within the mouth 600. In general, the one or more devices 606 may be a device operable as a marker, which is physically installed within the gingiva 602 at one or more locations within the mouth 600. The one or more devices 606 may be installed prior to the initial acquiring of scan data, and may remain in location or position until at least test-fitting (and optionally through final installation) of the restorative components occurs.

For example, the one or more devices 606 may be fasteners with a pre-determined design to assist in the positioning and locating of the devices 606 within the mouth 600 (e.g., during installation, during scanning, and the like). In some configurations, the pre-determined design for the fasteners may include, but is not limited to, a flat top that is positionable or locatable relative to the gingiva 602, which is used for the positioning and locating of the devices 606 within the mouth 600. In general, the devices 606 may be inserted within the gingiva 602, including extending from the gingiva 602, being flush with the gingiva 602, or being at least partially embedded within the gingiva 602, without departing from the scope of the present disclosure.

In some configurations, the design of the one or more devices 606 may include patterns (e.g., grooves, indentations, alphanumeric symbols, and the like) that allows for an automatic identification of the particular device 606 as installed within the gingiva 602. Optionally, this may be in combination with, or instead of, the pre-determined design (e.g., the flat-top) for the devices 606. In some configurations, the design of the one or more devices 606 may have a specific cross-section, width or diameter, length or other dimension that allows for an automatic identification of the particular device 606 as installed within the gingiva 602. In general, the one or more devices 606 may be configured to allow for an automatic identification of and, as needed, an adjustment or modification of the coordinate system in response to movement of the gingiva 602 (or, more generally, micro-movements of or in the mouth 600).

It should be understood, however, that the number of devices 606 in FIGS. 6A-6C is merely illustrative, and should not be interpreted as limiting on the present disclosure. In general, defining the coordinate system may require one or more devices 606 for each axis of the coordinate system. The one or more devices 606 may be individually relied upon for defining the axis (and, more generally, the coordinate system), or may be grouped together when relied upon to define the axis (and, more generally, the coordinate system). For example, three devices 606 located or positioned on the interfacing surface between the gingiva 602 and the restorative components to be designed and installed may be sufficient to provide the persistent points of reference for the coordinate system. In some configurations, the coordinate system may be a three-dimensional topographical map that is capable of adjustment or modification with shifting of the devices 606 that may be caused by movement of the gingiva 602 (or, more generally, micro-movements of or in the mouth 600) occurs.

It is contemplated that the installation of the devices 606 for purposes of coordinate system reference and/or restorative component installation may provide an increased benefit over alternative solutions such as reliance on reference features that exist within the mouth 600 (e.g., including impressions or projections on the gingiva 602 and/or remaining teeth 604). In particular, movement of the gingiva 602 (or, more generally, micro-movements of or in the mouth 600) may result in improper maintenance of the coordinate system through the restorative process. In addition, one potential shortcoming in creating restorative components that include perfectly-or substantially perfectly-matching surfaces with the gingiva 602 based on an initial scan is that the surfaces may not match changes in the surface (e.g., including any marked features on or in the surface) of the gingiva 602 during later stages of the restorative process. By using the devices 606 as persistent points of reference when defining (or adjusting or modifying) the coordinate system throughout the restorative process, the need for an increased surface area of contact is reduced and the level of invasiveness is reduced by staying away from significant anatomical features (e.g., where nerves are located), while the coordinate system is able to be maintained despite any movement of the gingiva 602 (or, more generally, micro-movements of or in the mouth 600) by not relying on anatomy of the gingiva 602 and/or remaining teeth 604

In embodiments, implementation of the initial coordinate system and subsequent adjustment or modification as needed may be accomplished using data models (e.g., data models 237, or other data models), where the data models are any self-evolving, artificial intelligence (AI)-based models (also referred to as self-learning, AI-based models), whether using supervised, unsupervised, or reinforcement learning methods, machine learning, deep learning, generative AI, computer vision or hybrid models, functions or capabilities or narrow AI, general AI, or super AI in scope. Common models include linear regression, decision trees, and deep neural networks.

It is contemplated that the acquired scan data and/or the data models may be stored in a library (e.g., model library 252, or other libraries), where the library is used for training data for subsequent data models. As will be appreciated, the acquired scan data may be used as training data to teach the self-learning, artificially intelligent data models how to make predictions regarding a design, locating, and position of a suitable restoration for oral conditions of a specific patient, recognize patterns such as treatment preferences for a specific care provider, or otherwise generate content. The library models can be labeled or unlabeled depending on the application. The training data can teach the data models not only how to match an existing dental restoration from one patient to another patient having similar oral characteristics but also how to select and combine dental restoration components from dental restorations to target different problems or issues in oral characteristics of a given patient. In one non-limiting example, the initial acquired scan data of the devices 606 may be used to train the data models to output the initial coordinate system, and subsequent sets of acquired scan data of the devices 606 may be input into the data models to output updates (e.g., adjustments, modifications, or the like) of the coordinate system.

In embodiments, the scan data may be incorporated into the workflows as described in U.S. patent application Ser. No. 19/573,963, incorporated herein by reference in the entirety, to ensure that the designs for the restorative components align with the coordinate system defined within the mouth 600. In one non-limiting example, the persistent points of reference defined by the location or position of the devices 606 may operate as locking points or anchor points for a surgical guide or other restorative component (e.g., a reinforcement bar or support member) utilized during the design and/or installation of the restorative components. In some instances, the reliance on the persistent points of reference may provide an increased or maximum level of confidence (e.g., 99.99% confidence, or the like) that the surgical guide or other restorative component is located or positioned in the mouth 600 where the surgical guide or other restorative component is also located or positioned in the virtual representation or virtual model of the mouth 600 utilized during the design process.

In some configurations, the devices 606 are located or positioned within the mouth 600 to not interfere with the final installation of the dental restoration. However, in other configurations the devices 606 may be located or positioned to have functions in addition to being the persistent points of reference for defining the coordinate system. In the above-non-limiting example for the surgical guide, which may be installed within the mouth 600 to remove material (e.g., osseous structure, gingival structure, and the like) from the installation site, the devices 606 may serve both as persistent points of reference for the defining of the coordinate system during designing and test-fitting (e.g., virtually and/or physically), and additionally operate as anchors to which the surgical guide is installed during the actual removal of material. In particular, the devices 606 may be used instead of the fixation pins that are utilized to secure standard surgical guides. With this dual use, a fewer number of less-invasive components need to be located or positioned in the mouth 600. In addition, the anesthesia may be more localized to specific locations on the gingiva 602 that correspond to the location or positions of the devices 606.

As described in the above embodiments, the devices 606 and resultant defined coordinate system may be relied upon for the initial scanning and design of the restorative components. However, in at least some embodiments the devices 606 and resultant defined coordinate system may be relied upon during the subsequent scanning, test-fitting, and installation of the restorative components, including during virtual reality and/or augmented reality applications.

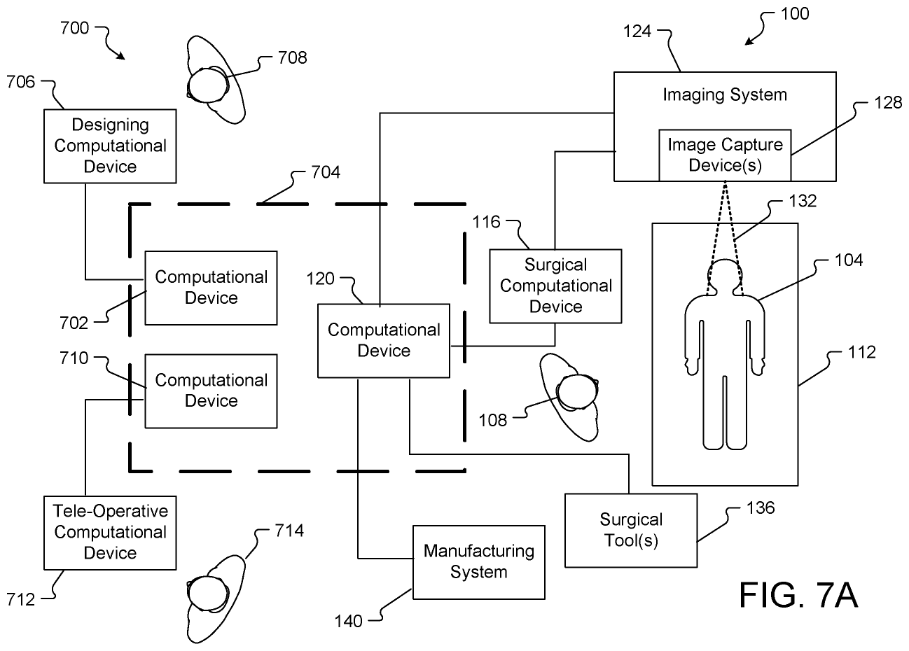

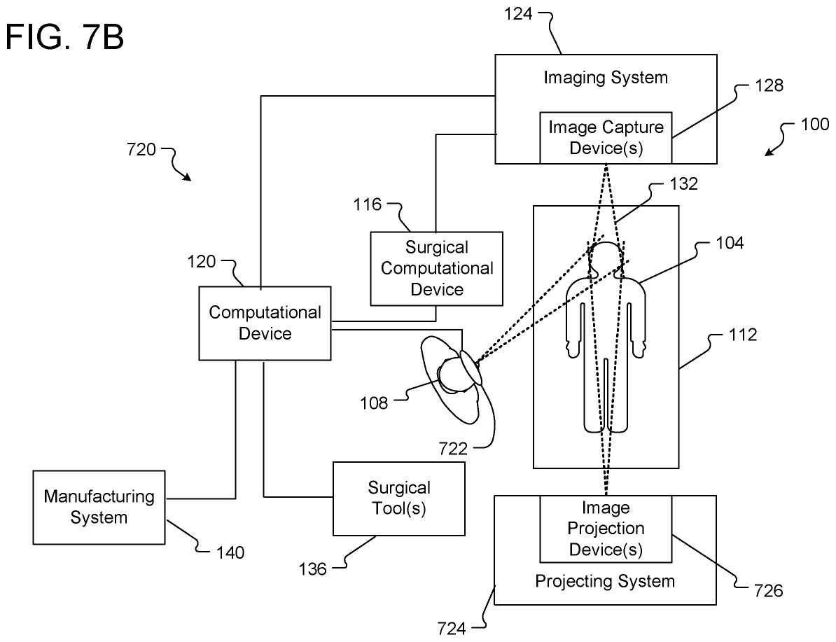

In some embodiments, as illustrated in FIG. 7A, the coordinate system may be utilized for establishing a virtual reality environment of the mouth 600 in which the devices 606 are located or positioned. For example, implementation of virtual reality may include the generating of a virtual representation of the mouth 600 based on the coordinate system, into which a virtual representation or virtual model of restorative components (either pre-existing or patient-specific and designed including optionally via the workflows described herein) may be located and positioned.

In general, a care provider (e.g., a surgeon or other medical professional) may utilize virtual reality to practice, test-fit, perform surgery to prepare the restoration site, or other operations that may be performed during the restorative process based on the coordinate system generated from the scanning of the devices 606. This may occur at multiple stages of the restorative design, test-fit, and/or installation, including optionally with additional scans of the devices 606 to observe if any movement of the gingiva 602 (or, more generally, micro-movements of or in the mouth 600) has occurred. If movement is observed based on shifting of the location or position of the devices 606, the virtual representation of the mouth 600 may be modified or adjusted and the design virtual representation or virtual model of the restorative components may be similarly modified or adjusted.

In one-non limiting example, virtual reality may be utilized in a laboratory or other manufacturing facility setting when designing the restorative components, by aligning CAD models of the restorative component with acquired scan data of the mouth 600 based on the coordinate system. Referring to a system 700 in FIG. 7A, the computational device 120 of the system 100 of FIG. 1 is optionally in communication with a computational device 702 (e.g., via wired or wireless communications 704). The computational device 702 is in communication with a designing computational device 706, such that information from system 100 (e.g., image data of the devices 606) may be provided to a care provider 708. Using the defined coordinate system, the care provider 708 may design one or more parameters of the restorative components based on the information received from the system 100 in a virtual reality space, including optionally providing commands to the care provider 108 to manufacture the restorative components in real-time with the manufacturing system 140.

In another non-limiting example, virtual reality may be utilized for tele-operation procedures including, but not limited to, pre-operative planning, pre-operative training, robotic-assisted surgeries, and the like. Referring again to the system 700 in FIG. 7A, the inputs from acquired scan or image data from the imaging system 124 (e.g., including optionally taken in real-time) of the patient undergoing surgery to install the dental restoration may be inputted into a data model that is trained based on the coordinate system for robotic-assisted surgeries. The data model outputs the virtual representation of the mouth 600 (and/or any adjustments or modifications thereof) being utilized for pre-operative planning, pre-operative training, tele-operated robotic-assisted surgeries, and the like to a computational device 710 and/or a tele-operative computational device 712. As needed in response to movements of or in the mouth 600, the data model may modify or adjust the virtual representation of the mouth 600 based on the defined coordinate system.

Following the display of the virtual model of the mouth 600 and a virtual representation of the restorative component, user inputs and/or programmable commands from a care provider 714 may be received via the tele-operative computational device 712 and input into the data model. The data model then outputs and provides control instructions (e.g., via the computational device 120) for movement of robotic assemblies (e.g., surgical tools 136) at the site of surgery. As needed in response to movements of or in the mouth 600, the data model may modify or adjust the user inputs and/or programmable commands based on the defined coordinate system prior to movement of robotic assemblies at the site of surgery. It is noted that “tele-operated” as used throughout the present disclosure includes, but is not limited to telecommunications, videocommunications, and the like.

It is noted that the data model may be stored and executed on one or more of the computational devices 116, 120, 702, 706, 710, 712, without departing from the scope of the present disclosure. In addition, it is noted that computing device 200 of FIG. 2 may be one exemplary configuration of the one or more of the computational devices 116, 120, 702, 706, 710, 712, for purposes of the present disclosure.

Although embodiments of the present disclosure are directed to multiple computational devices 116, 706, 712 in communication with computational devices 120, 702, 710, it should be understood that there may be more or fewer computational devices without departing from the scope of the present disclosure. In one non-limiting example, one or more of the designing computational device 706 and/or the tele-operative computational device 712 may be in communication with the computational device 702 without the intervening respective computational devices 702, 710.

In some embodiments, as illustrated in the system 720 in FIG. 7B, the coordinate system may be utilized for establishing an augmented reality environment of the mouth 600 in which the devices 606 are located or positioned. For example, implementation of augmented reality may include the generating of a virtual representation of the mouth 600 based on the coordinate system, into which a virtual representation or virtual model of restorative components (either pre-existing or patient-specific and designed including optionally via the workflows described herein) may be located and positioned.

The care provider 108 may utilize augmented reality devices (e.g., glasses 722 or other worn optical devices, a projecting system 724 with projection devices 726, or the like) that overlay the virtual representations (e.g., CAD model imaging) of the restorative components on the actual mouth 600 of the patient during the subsequent testing and installation of the restorative components. It is noted that the imaging system 124 and the projecting system 724 may be the same or different systems, for purposes of the present disclosure.

It is noted that the program instructions for the workflows described throughout the present disclosure (or, alternatively, extensions or applications operable to perform alongside the described program instructions) are capable of overlaying the virtual representation of the restorative components on the image of the actual mouth 600. The overlay of the virtual representation of the restorative components on the image of the actual mouth 600 allows for the test-fitting or installing of the restorative components based on the coordinate system generated from the scanning of the devices 606, including adjusting or modifying the projected overlay based on changes to the mouth 600 observed when movement of the gingiva 602 (or, more generally, micro-movements of or in the mouth 600) occurs.

In one non-limiting example, the augmented reality imagery may be provided using glasses 722 or other worn optical devices, though which the care provider 108 can see the mouth 600 of the patient. The viewing lenses of the glasses 722 or other worn optical devices are configured to operate as at least partially transparent displays for the augmented reality imagery, with components including, but not limited to, cameras, microphones, speakers, physical toggle and/or capacitive touch controls, processors, memory, sensors, Tx/Rx connections, and the like. Alternatively, projectors on the glasses 722 or other worn optical devices may project the augmented reality imagery onto either the viewing lenses (e.g., similar to a heads-up display) or directly onto the patient from the glasses 722.

In another non-limiting example, the augmented reality imagery may be projected using a projecting system 724 onto a mouth 600, instead of using the worn optical devices. In a further non-limiting example, the augmented reality imagery may include virtual representations of the restorative components that are displayed on the surgical computational device 116 which simultaneously or substantially simultaneously displays captured image data of the mouth 600 during the test-fitting and/or installation of the restorative components. Here, the surgical computational device 116 or other computational device is in communication with a processing device that generates (or receives) and outputs the augmented reality imagery, and also acquires real-time (or substantially real-time image data of the mouth 600, and overlays the augmented reality images onto the acquired image data.

Inputs such as the virtual representations of the restorative components and the captured images may be provided to the data models trained on the defined coordinate system, and outputs may be provided that overlay, and/or adjust or modify, the virtual representations and/or the defined coordinate system based on changes to the mouth 600 observed from the scanning of the devices 606. With the augmented reality imagery overlaid onto the mouth 600 based on the coordinate system defined based on the persistent points of reference generated by the installed devices 606, the care provider 108 is able to more easily and efficiently test-fit and/or install the restorative components while also taking into consideration movement of the gingiva 602 (or, more generally, micro-movements of or in the mouth 600). The overlay being based on the defined coordinate system also reduces or prevents possible unalignment of the overlay from the mouth 600 of the patient, as the augmented reality overlay is adjusted by the data model or other processing element to maintain alignment between the overlay and the mouth of the patient based on the persistent points of reference.

In this regard, the data models assist in reducing the possibility of error during the various stages of the restorative process, while opening up the restorative process to include additional beneficial ways to connect with the patient who are not immediately available to the care provider. For example, the care provider may be localized to a particular area (e.g., ranging from within the same room to halfway around the world), but able to assist patients using tele-consultation and/or tele-operation procedures.

It is noted that any embodiments directed to the system 100 of FIG. 1 may be directed to the system 100 of FIG. 7A-7B, and vice versa, without departing from the scope of the present disclosure.

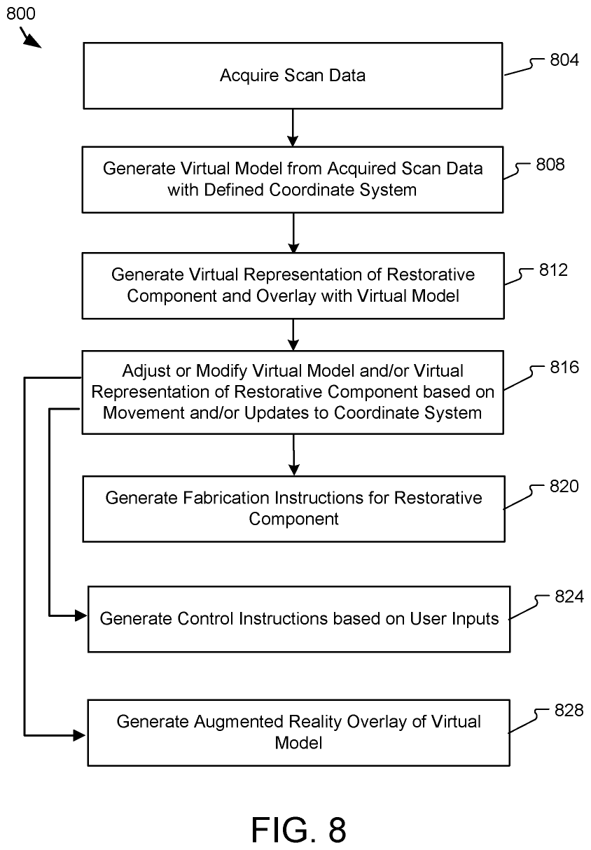

FIG. 8 is a flow diagram 800 of the operations described with respect to FIGS. 7A and 7B, in accordance with one or more embodiments of the present disclosure. It is noted that some or all of the operations described with respect to FIG. 8 may be performed by one or more actors, without departing from the scope of the present disclosure.

In embodiments, scan data is acquired 804. The scan data may be of a mouth 600 of a patient. The scan data may include persistent points of reference generated from the scanning of devices 606 installed within the mouth 600, to define a coordinate system.

In embodiments, a virtual model is generated 808 based on acquired scan with defined coordinate system. The scan data may be input into a data model, which is trained on the scan data to generate a defined coordinate system. The data model outputs a virtual model of the mouth 600. It is noted that the virtual model may be saved as a library model for future use, including optionally future training of the workflows as described throughout the present disclosure.

In embodiments, a virtual representation of a restorative component is generated 812 and overlaid with the virtual model. For example, the virtual representation may be generated based on user input from a care provider 708. By way of another example, the data model may output a virtual representation selected from a library, based on a comparison of the scan data of the mouth 600. It is noted that data model-outputted virtual representations may be used as-is or further refined by a care provider 708. It is noted that the virtual representation may be saved as a library model for future use, including optionally future training of the workflows as described throughout the present disclosure.

In embodiments, the virtual model and/or the virtual representation of the restorative component is adjusted or modified 816 based on movement and/or updates to coordinate system. For example, updated scan data may be acquired and input into the data model which may output updates to the virtual model. By way of another example, the updates to the virtual model, including optionally updates to the coordinate system, may cause the data model to generate updates to the virtual representation selected from the library.

In embodiments, fabrication instructions are generated 820 for the restorative component. The data model may receive a finalized iteration of the virtual representation of the restorative component and output fabrication instructions to manufacture the restorative component.

In embodiments, control instructions are generated 824 based on user inputs. Where a care provider 714 is using the virtual model and virtual representation for tele-operations, the data model may receive user inputs from the care provider 714 and output control instructions to manipulate one or more components of the system 100 (e.g., the surgical tools 136) as described throughout the present disclosure.

In embodiments, augmented reality overlays of the virtual model are generated 828. The data model may receive the virtual model and/or virtual representation, and output an overlay onto the mouth 600, either indirectly through displays or directly through projection, for the care provider 108. It is noted that any or all of the described augmented reality overlays may be implemented separately or simultaneously, without departing from the scope of the present disclosure.

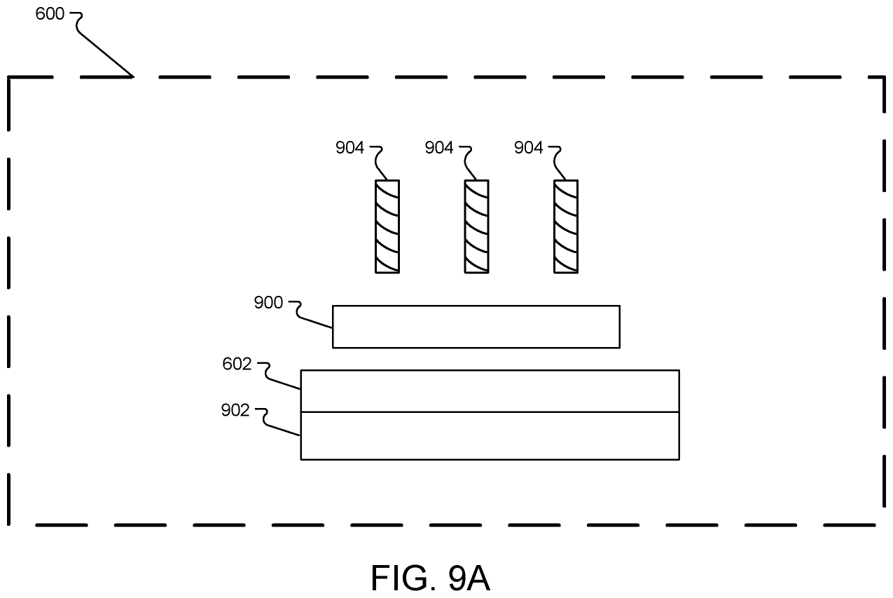

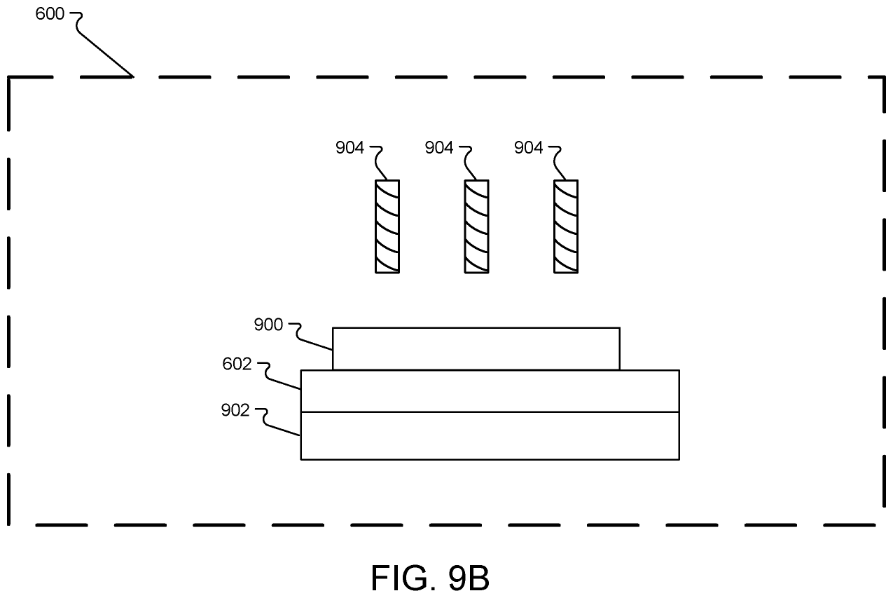

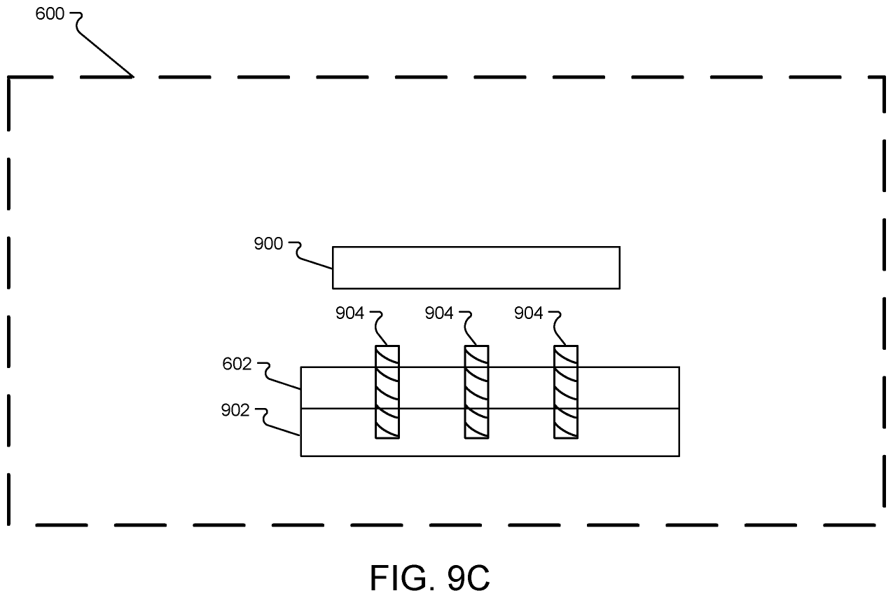

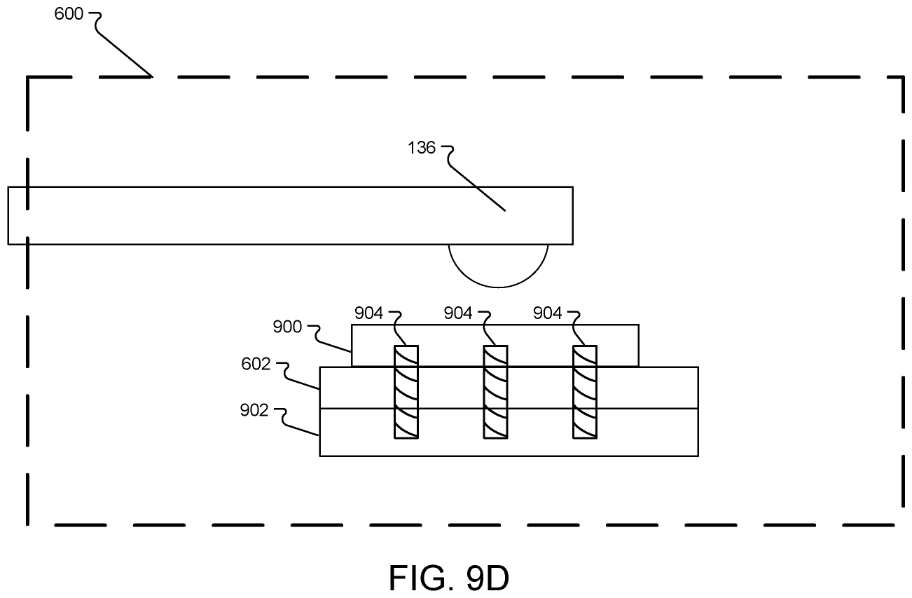

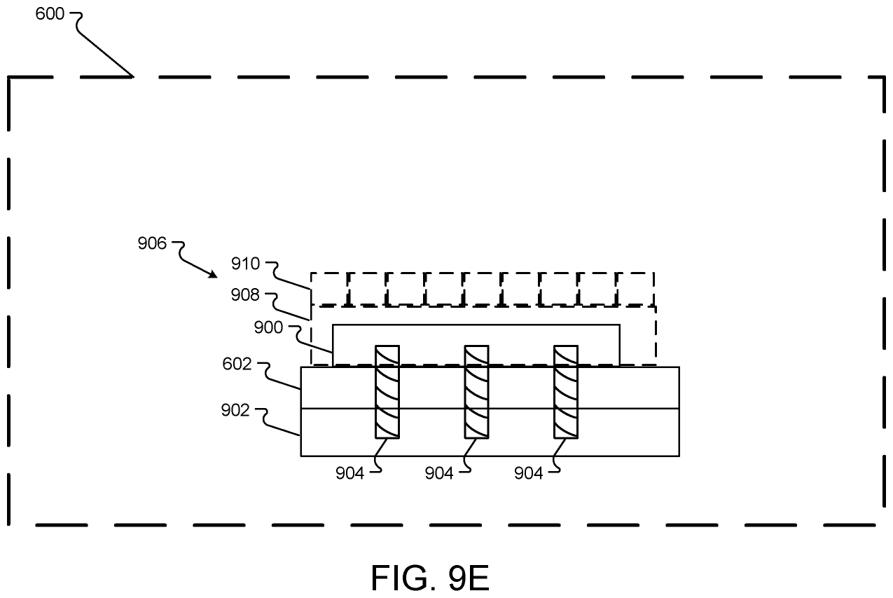

FIGS. 9A-9E illustrate a dual-use or dual-function restorative component 900, in accordance with one or more embodiments of the present disclosure. In particular, FIGS. 9A-9E illustrate the dual-function restorative component 900 within a mouth 600 with an osseous structure 902 (e.g., a mandible or a maxilla) and the gingiva 602. Although FIGS. 9A-9E may be understood as illustrating a full arch dental restoration utilizing a reinforcement bar or support member, it is contemplated that the dual-function restorative component 900 may be used for any type of partial or full dental restoration, including optionally bridges and/or single unit installations, as described throughout the present disclosure.

In select restorative processes, installation of a bar-based partial or full dental restoration involves the installation of a surgical guide (e.g., with fixation pins). After modification of the osseous structure 902 occurs, the surgical guide is removed and implants 904 are installed within the osseous structure 902 to receive a reinforcement bar or support member for a restorative prosthesis 906. It is noted that the reinforcement bar or support member may couple directly to the implants 904, or may couple to intervening abutments that are first coupled to the implants 904.

These restorative processes require considerable modification of the osseous structure 902 to receive both the fixation pins and the implants 904, resulting in increased discomfiture and/or risk of injury (or death) for the patient during the restorative process. These issues are further increased where a temporary or provisional reinforcement bar or support member is first installed, which is later removed prior to installation of a final reinforcement bar or support member for the restorative prosthesis. In addition, these additional operations to install the multiple components, required as part of the restorative processes, increase the possibility of stacked error in tolerances between the various installed (and optionally removed) components, including errors caused by movement of the gingiva 602 (or, more generally, micro-movements of or in the mouth 600).

In embodiments, the restorative component 900 is usable as a surgical guide for modifying the osseous structure 902. As illustrated in FIG. 9A, the restorative component 900 is located or positioned on the osseous structure 902 and the gingiva 602. For example, the position or location of the restorative component 900 may be determined using one or more of the workflows and/or process flows as described in U.S. patent application Ser. No. 19/573,963, incorporated herein by reference in the entirety. By way of another example, the position or location of the restorative component 900 may be determined based on the persistent points of reference which define the coordinate system, as illustrated in FIGS. 6A-6C.

In some non-limiting examples, as illustrated in FIG. 9B and FIG. 9D, the restorative component 900 is located or positioned on the gingiva 602 to receive the implants 904 that secure the restorative component 900 to the osseous structure 902 through the gingiva 602. In other non-limiting examples, as illustrated in FIG. 9C and FIG. 9D, the implants 904 may serve a dual purpose and be installed prior to the restorative component 900, including both as the attachment features that secure the restorative component 900 to the osseous structure 902 and as the persistent points of reference for defining the coordinate system (i.e., similar to the devices 606). As such, it is contemplated that the restorative component 900 may be configured to receive the implants 904 (e.g., as illustrated in FIG. 9B) or may be configured to be installable on the implants 904 (e.g., as illustrated in FIG. 9C), without departing from the scope of the present disclosure.

As illustrated in FIG. 9D, once the restorative component 900 is secured to the osseous structure 902, the restorative component 900 may be utilized as a surgical guide. For example, the surgical guide may be configured to receive one or more surgical tools 136 as described throughout the present disclosure to modify the osseous structure 902 to better fit a final restorative component.

As illustrated in FIG. 9E, however, the restorative component 900 is also configured as a reinforcement bar or support member that receives the test-fit and/or the final restorative prosthesis 906. For example, the restorative prosthesis 906 may include a body 908 that is dimensioned to receive the restorative component 900, and one or more artificial teeth 910.

In some configurations, the restorative prosthesis 906 receives fasteners that also engage the restorative component 900, securing the restorative prosthesis 906 to the restorative component 900. In other configurations, the restorative prosthesis 906 and the restorative component 900 may alternatively or in addition have corresponding features of an interlocking assembly that couple together to secure the restorative prosthesis 906 to the restorative component 900. Optionally, an adhesive may be applied to (optionally further) secure the restorative prosthesis 906 to the restorative component 900.

It is contemplated that the restorative component 900 may be configured for one or both of the fasteners and the interlocking assembly. For example, a test-fit restorative prosthesis 906 may utilize the interlocking assembly, while the final restorative prosthesis 906 may utilize the fasteners, or vice versa. In general, the restorative component 900 being configured for one or both of the fasteners and the interlocking assembly allows for the option by the surgeon or other medical professional, and the patient in whose mouth 600 the restorative prosthesis 906 is installed, to be able to securely attach or removably attach the restorative prosthesis 906 to the restorative component 900 (e.g., as desired by the surgeon or other medical professional, and/or the patient).

In this regard, the restorative component 900 is dual-function, being operable both as a surgical guide and as a reinforcement bar or support member during the course of the dental restoration process. Because of the dual function, utilizing the restorative component 900 reduces the number of components needed during the dental restoration process, and the amount of impact on the patient that may otherwise occur with having to modify the osseous structure 902 for fixation pins for a standard surgical guide and additionally for the implant 904 used to attach the restorative prosthesis 906 to the osseous structure 902.

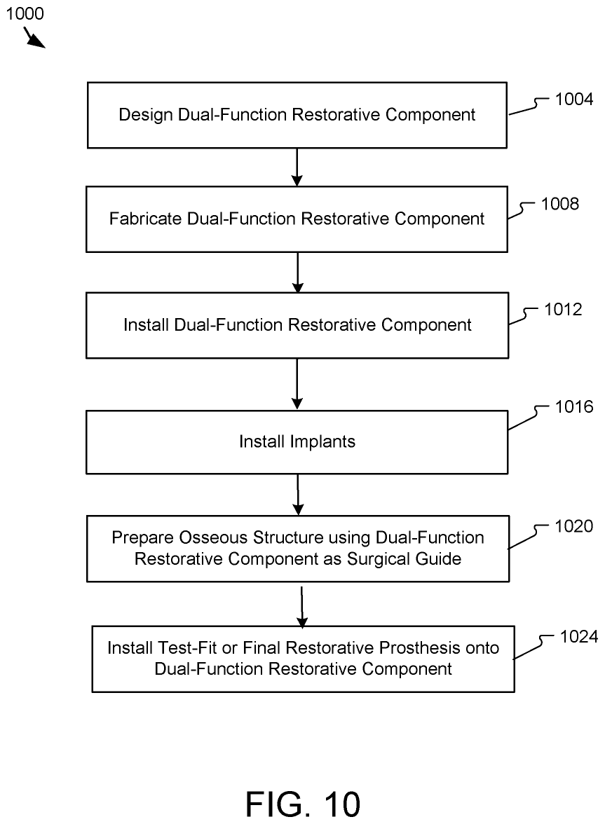

FIG. 10 is a flow diagram 1000 of the operations described with respect to FIGS. 9A-9E, in accordance with one or more embodiments of the present disclosure. It is noted that some or all of the operations described with respect to FIG. 10 may be performed by one or more actors, without departing from the scope of the present disclosure.

In embodiments, a dual-function restorative component is designed 1004. For example, acquired scan data of the osseous structure 902, gingiva 602, and/or remaining teeth 604 in a mouth 600 may be input into a data model that is optionally trained a defined coordinate system from devices 606 installed within the mouth 600, and a virtual model of the mouth 600 is output. For the virtual model, a virtual representation of the restorative component 900 is designed or selected from a library (including optionally modified to better fit the patient from the initial library file). It is noted that the data model may output the virtual representation of the restorative component 900, or that a care provider 708 may generate the design.

In embodiments, the dual-function restorative component is fabricated 1008. For example, the virtual representation may be input into the data model, which output control instructions for fabrication of the restorative component 900. Alternatively, a care provider may manually fabricate (either by hand or through self-generated inputs to a fabricator) the restorative component 900.

In embodiments, a dual-function restorative component is installed 1012 and implants are installed 1016. In some configurations, the restorative component 900 is located or positioned on the gingiva 602, and the implants 904 are inserted through the restorative component 900. In other configurations, implants 904 are first installed in the osseous structure 902 (e.g., including optionally to be used as the devices 606 for defining the coordinate system), and the restorative component 900 is located or positioned on the gingiva 602 over the implants 904.

In embodiments, the osseous structure is prepared 1020 using the dual-function restorative component as a surgical guide. The restorative component 900 is operable to receive one or more surgical tools 136 as described throughout the present disclosure.

In embodiments, a test-fit or final restorative prosthesis is installed 1024 onto the dual-function restorative component. Following preparation of the osseous structure, the restorative component 900 remains installed within the mouth 600. For bar-based dental restorations, the restorative component 900 (with the implants 904) is usable as a reinforcement bar or support member for a restorative prosthesis 906. In general, however, the restorative component 900 (with the implants 904) is usable to couple any restorative prosthesis 906, including via fasteners, interlocking assemblies, and/or adhesives, to the osseous structure 902.

With the inclusion of the computational devices 116, 120, 702, 706, 710, 712, and the computing device 200, it is noted that at least some embodiments of the present disclosure may be considered directed to a computer-implemented invention and/or be able to perform operations of a computer-implemented method.

In this regard, advantages of the present disclosure provide solutions to a number of different problems associated with CAD tools and the use of CAD tools in connection with planning or performing surgical procedures and dental reconstructions. As an example, embodiments of the present disclosure provide CAD tools that are configured to generate and manipulate freeform objects across multiple dimensions, including optionally based on a persistent coordinate system. Advantages of the present disclosure also provide CAD tools that can communicate with a manufacturing system, which can produce complex physical items according to the objects defined in the CAD tools. The flexibility and customization offered by the CAD tools proposed herein supports the ability to rapidly create customized surgical guides, stacked guides, stacked components, cutting templates, dual-function restorative components operable as a guide and a support member for temporary or final dental prosthesis components, dental restoration systems and components thereof, or the like in real-time, which translates to improved patient outcomes and/or reduced chair time for a patient during a surgical procedure.

The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the foregoing has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system for installation of a dental restoration, comprising:
a plurality of devices installable within a mouth of a patient, the plurality of devices being scannable as persistent points of reference during one or more operations of a dental restoration process; and
a computerized device including processors configured to execute program instructions stored in memory, wherein the program instructions are configured to cause the processors to:
acquire scan data of the plurality of devices when installed within the mouth of the patient;
define a coordinate system based on the acquired scan data;
generate a virtual model of the mouth of the patient using the defined coordinate system; and
generate a virtual representation of a restorative component of the dental restoration that aligns with the virtual model of the mouth based on the defined coordinate system.

2. The system of claim 1, wherein the generating the virtual representation of a restorative component of the dental restoration comprises at least one of:
receiving one or more user inputs from a care provider to define one or more parameters of the restorative component; and
selecting the virtual representation of the restorative component from a library.

3. The system of claim 2, wherein when the virtual representation is selected from the library, the generating the virtual representation of a restorative component of the dental restoration further comprises modifying the selected virtual representation of the restorative component in response to one or more user inputs from a care provider to define one or more parameters of the restorative component.

4. The system of claim 1, wherein the program instructions are configured to cause the processors to:
generate one or more fabrication instructions for a manufacturing system to manufacture the restorative component.

5. The system of claim 1, wherein the program instructions are configured to cause the processors to:
provide the virtual model of the mouth and the virtual representation of the restorative component to a care provider;
receive one or more user inputs from the care provider; and
generate one or more control instructions for at least one surgical tool in response to the one or more user inputs based on the defined coordinate system.

6. The system of claim 1, wherein the program instructions are configured to cause the processors to:
generate an augmented reality overlay of at least one of the virtual model and the virtual representation of the restorative component on the mouth of the patient based on the defined coordinate system,
wherein when movement of at least one of a care provider or the patient occurs, the defined coordinate system maintains alignment between the augmented reality overlay and the mouth of the patient.

7. The system of claim 6, wherein the augmented reality overlay is one or more of:
displayed on lenses of a worn optical device comprising glasses for the care provider;
projected onto the mouth of the patient from a worn optical device comprising glasses for the care provider; and
projected onto the mouth of the patient from a separately-standing projecting system.

8. The system of claim 1, wherein the restorative component is a dual-function restorative component.

9. The system of claim 8, wherein the dual-function restorative component is installable within the mouth of the patient and usable as a surgical guide to modify an osseous structure of the patient.

10. The system of claim 9, wherein the dual-function restorative component is configured to receive implants to secure the dual-function restorative component to the osseous structure of the patient.

11. The system of claim 9, wherein the dual-function restorative component is configured to engage pre-installed implants within the mouth of the patient to secure the dual-function restorative component to the osseous structure of the patient.

12. The system of claim 11, wherein the pre-installed implants are the plurality of devices that are scannable as the persistent points of reference during one or more operations of the dental restoration process.

13. The system of claim 9, wherein the dual-function restorative component remains installed within the mouth of the patient as part of the dental restoration post-modification of the osseous structure, and wherein the dual-function restorative component is operable as a support member and configured to receive and engage with a restorative prosthesis via at least one of a fastener or an interlocking assembly.

14. The system of claim 1, wherein the program instructions are further configured to cause the one or more processors to:
in response to observed changes in a location or a position of the plurality of devices in the mouth of the patient from additional acquired scan data, update one or more of the defined coordinate system, the generated virtual model of the mouth, and the generated virtual representation of the restorative component.

15. The system of claim 1, wherein the plurality of devices are removably installable during the dental restoration process, to be removed upon completion of the dental restoration process.

16. The system of claim 1, wherein the plurality of devices are installed during the dental restoration process and remain as components of the dental restoration.

17. A dual-function restorative component for a dental restoration, the dual-function restorative component being usable as a surgical guide and configured to receive one or more surgical tools to modify an osseous structure of a patient when the dual-function restorative component is installed within a mouth of the patient, the dual-function restorative component being operable as a support member and configured to receive and engage with a restorative prosthesis via at least one of a fastener or an interlocking assembly post-modification of the osseous structure of the patient.

18. A method, comprising:
acquiring scan data of a plurality of devices when installed within a mouth of a patient;
defining a coordinate system based on the acquired scan data;
generating a virtual model of the mouth of the patient using the defined coordinate system; and
generating a virtual representation of a restorative component of a dental restoration that aligns with the virtual model of the mouth based on the defined coordinate system.

19. The method of claim 18, comprising:
providing the virtual model of the mouth and the virtual representation of the restorative component to a care provider;
receiving one or more user inputs from the care provider; and at least one of:
generating one or more fabrication instructions for a manufacturing system to manufacture the restorative component;
generating one or more control instructions for at least one surgical tool in response to one or more user inputs based on the defined coordinate system; and
generating an augmented reality overlay of at least one of the virtual model and the virtual representation of the restorative component on the mouth of the patient based on the defined coordinate system, wherein when movement of at least one of the care provider or the patient occurs, the defined coordinate system maintains alignment between the augmented reality overlay and the mouth of the patient.

20. The method of claim 18, wherein the restorative component is a dual-function restorative component operable as a surgical guide as a support member for a restorative prosthesis.
